(19) United States
(12) Patent Application Publication
(10) Pub. No.: US 2008/0251195 A1
(43) Pub. Date: Oct. 16, 2008

(54) Activated anaerobic adhesive and use thereof

(75) Inventors: Bernard M. Malofsky, Bloomfield, CT (US); Adam G. Malofsky, Loveland, OH (US); Lisa M. Fine, Delaware, OH (US)

Correspondence Address: EDWARD K. WELCH II;IP&L Solution, 4558 Ashton Court, Naples, FL, 34112, US

(73) Assignee: ABM Associates LLC

(21) Appl. No.: 11/784,787

(22) Filed: Apr. 10, 2007

(51) Int. Cl. B29C 65/48; C08G 61/00

(52) U.S. Cl. 156/275.5; 525/343; 525/360; 525/370; 525/387; 525/55

(57) ABSTRACT

Activated anaerobically curable adhesive compositions are prepared by exposing anaerobic adhesive compositions containing a strong acid precursor, especially a sulfonium salt, to UV light for up to 20 seconds.

### FIELD OF THE INVENTION

This invention relates to a UV activated anaerobically curable adhesive compositions and a method of bonding using said adhesive compositions. More particularly, it relates to anaerobic adhesive compositions that have been activated by exposing an anaerobic adhesive composition containing a UV activated strong acid precursor to UV light for up to 20 seconds, typically up to 5 seconds, so as to generate sufficient strong acid to promote free radical generation in a sufficient amount so as to facilitate cure of the anaerobic adhesive composition upon the exclusion of air. Finally, the present invention also relates to a method of bonding wherein the anaerobic adhesive is exposed to UV light for up to 20 seconds, typically up to 5 seconds, prior to forming the bond.

### BACKGROUND OF THE INVENTION

Many applications require two surfaces to be adhered together and various adhesive formulations involving a multitude of cure methodologies have been developed for this purpose. Despite the considerable research in this area, there continues to be drawbacks to the various adhesive formulations and cure methods. The ideal adhesive formulation will have a long shelf life, i.e., free of gel formation during shipping and/or storage, and be easy to use. Preferably, these adhesives will have long open times, i.e., be stable after application to the surface to be bonded. However, when the adhesive coated surface is mated with a second surface, the adhesive composition should quickly cure and provide good adhesion and, preferably high bond strength, in as short a time as possible. One of the more common adhesive materials, epoxy based adhesive compositions, provide excellent adhesion, but the compositions are not stable. Typically, these are stored and shipped as two-part formulations, with the final composition being made just prior to application. Even then, these materials must be used quickly as cure is typically initiated once the two parts are mixed. As such, this type of adhesive composition entails added costs and effort associated with the dual packaging and mixing steps as well as increased waste of materials that cure prematurely or whose viscosity increases too high before the materials can be used. Furthermore, there is concern with mixing the two components in their proper amounts and doing so consistently so as to ensure repeatable bond strengths from one application to another.

Other adhesive compositions require various conditions to effect cure. For example, certain adhesives, especially various urethane and/or silicone based adhesive compositions require the presence of moisture to effect cure. However, one cannot always guarantee sufficient ambient moisture to ensure a suitably fast cure. Alternatively, in high humidity environments premature curing may arise before the user has properly oriented the surfaces to be bonded or cure strength may be affected because of continued working of the adhesive while cure is taking place. Other adhesives require a heat or actinic radiation cure. Although effective cure mechanisms, both of these are impractical for many applications and typically involve long cure periods during which the high temperature and/or actinic radiation exposure must be maintained. Although lower temperature activated initiators or catalysts and more sensitive actinic radiation activated initiators or catalysts may overcome some of the problems associated with these adhesives, they oftentimes also lead to premature curing or viscosity build up in the adhesive composition, especially during storage and/or transport. While the latter may be addressed by the incorporation of various stabilizers, their presence, especially if high levels are employed, may necessitate the use of more severe curing conditions to effect cure and/or longer, most often considerably longer, exposure to the curing conditions.

One of the more versatile and easy to use family of adhesives are those known as anaerobic adhesives. These are characterized by their ability to cure in the substantial absence of air while remaining liquid in the presence of air. However, these too have problems with premature curing, especially if they are stored in bulk or in non-air permeable containers and/or the containers do not have an adequate headspace to ensure ready availability of cure inhibiting oxygen. Another, perhaps more significant problem, is their lack of cure or poor cure characteristics, including bond strength, when employed on inactive or poorly active surfaces (e.g., plastics, glass, stainless steel, etc.) and/or where the adhesive must bridge or fill large gaps. Although these concerns may be addressed, at least in part, by using heat, two-part systems, and/or primers, each entails added costs, equipment and processing/fabrication steps. Furthermore, the use of primers involves the use of solvents and the concomitant release or generation of noxious fumes or vapors.

In order to address some of the foregoing problems, Conway et. al. (U.S. Pat. No. 4,533,446) provided radiation-activatable anaerobic adhesive formulations comprising an anaerobically polymerizable acrylate ester monomer; an onium, preferably an iodonium, compound which decomposes to a strong acid upon exposure to ultraviolet or visible light; a peroxy free radical initiator; and an activator of anaerobic polymerization. Activation of these compositions is achieved by exposing the same to ultraviolet or visible light for at least a minute and one-half, preferably several minutes to about four minutes, at sufficient intensity so as to provide at least about 1170 mJ/cm² of energy to the adhesive. Shorter and longer exposure times, with the concomitant lower or higher energy absorption, respectively, are taught to result in no cure or poor bond strengths. Given the long exposure times, such formulations appear impractical and unsuitable for high speed bonding operations, especially automated, industrial manufacturing, bonding, and assembly operations.

Despite the significant amount of research and advancements with anaerobic adhesives over the past two decades, there remains a need for stable, anaerobic adhesive compositions that can be activated quickly and on demand and which are capable of use in high speed, especially automated, manufacturing, bonding and assembly applications. In particular, there is a need for an anaerobically curable adhesive composition which can be activated by UV light in 20 seconds or less, preferably in 5 seconds or less, most preferably in fractions of a second, and still provide excellent bond cure characteristics and bond strengths.

Additionally, there is a need in the industry for high speed bonding and assembly processes which employ stable, anaerobically curable adhesives, especially anaerobically curable compositions which are suitable for active and inactive surfaces. In particular, there is a need in the industry for high speed bonding and assembly processes which employ anaerobic adhesive compositions that are capable of being activated upon demand and in relatively short time periods, generally in about 20 seconds or less, more typically in about 5 seconds or less, preferably in a second or less, most preferably a fraction of a second.

### SUMMARY OF THE INVENTION

In accordance with the present invention there are provided activated, anaerobically curable adhesive compositions comprising
(i) one or more free radical polymerizable monomers, oligomers, prepolymers or a combination of any two or more of the foregoing,
(ii) a peroxy free radical initiator,
(iii) a strong acid, and
(iv) optionally, except where the adhesive is to be employed on an inactive surface in which case it is not optional, a transition metal ion source, most preferably a transition metal metallocene, especially ferrocene;
   wherein the strong acid has been generated in-situ from a UV activated strong acid precursor as a result of exposing the anaerobic adhesive composition containing the strong acid precursor to a UV light source for from about 0.01 up to 20 seconds, preferably from about 0.05 seconds up to 5 seconds: said strong acid being capable of interacting with the peroxy free radical initiator in the presence of a transition metal ion to generate free radicals in a sufficient amount to enable the composition to “fully cure” under anaerobic conditions in less than 24 hours, preferably in less than 4 hours, and most preferably in less than about 1 hour. Most desirably, these compositions will provide a fixture to the mated surfaces within 2 hours, typically within 1 hour, preferably with fifteen minutes, most preferably within a minute. In a preferred embodiment, activation is accomplished in 2 seconds or less, most preferably in less than a second. Typically the free radically polymerizable component (i) comprises one or, preferably, a mixture of acrylate esters.

A second aspect of the present invention pertains to a method of bonding surfaces with an anaerobic adhesive composition, said method comprising:
a) coating a first surface with an anaerobic adhesive composition;
b) exposing the anaerobic adhesive composition to UV light for up to about 20 seconds, more typically up to about 5 seconds;
c) mating the coated first surface with a second surface so as to substantially exclude air from interacting with the anaerobic adhesive composition; and
d) allowing the anaerobic adhesive formulation to cure,
   said method steps (a) and (b) occurring sequentially, concurrently or in reverse order; wherein the anaerobic adhesive composition, prior to exposure to the UV light, comprises (i) one or more free radical polymerizable monomers, oligomers, prepolymers or a combination of any two or more of the foregoing, (ii) a peroxy free radical initiator, preferably a peroxide, (iii) a UV activated strong acid precursor, and (iv) optionally, except where the adhesive is to be employed on an inactive surface in which case it is not optional, a transition metal ion source, most preferably a transition metal metallocene, especially ferrocene or a substituted ferrocene; whereby the exposure of the anaerobic adhesive composition to UV light generates a strong acid, said strong acid being capable of interacting with the peroxy free radical initiator in the presence of the transition metal ion, preferably ferrocene or a substituted ferrocene compound, to generate free radicals in a sufficient amount to enable the composition to cure under anaerobic conditions in less than 24 hours, preferably less than about 4 hours, most preferably in less than 1 hour. Most desirably, the present method will provide a fixture to the mated surfaces within 2 hours, typically within 1 hour, preferably with fifteen minutes, most preferably within a minute.

Although the method is suitable for any number of applications, it is especially suited for a high speed industrial manufacturing or assembly operations wherein the adhesive is applied to a first substrate, especially a sheet, film or film-like first substrate, which is to be bonded to second substrate (which may also be merely another surface of the first substrate) wherein the adhesive composition is applied as a thin film to at last a portion of the first substrate, activated and then mated with the second substrate.

Similarly, this process is especially suited for high speed processes where line speed and the combining of process steps is of significant value in increased production and/or saving time and manufacturing costs. For example, this process will prove of particular interest and benefit to the making of multi-layered films, and of flexible and rigid laminate structures as well as in the application of labels, decorative films, articles and the like to a substrate.

### DETAILED DESCRIPTION OF THE INVENTION

The present invention pertains to activated anaerobic adhesive, sealant and binder compositions wherein the anaerobic cure mechanism has been activated by exposing the composition to UV light for periods of about 20 seconds or less, preferably about 5 seconds or less. For convenience, the invention is described in relation to adhesives in the specification and appended claims, though sealant and binder applications are intended as well. As used herein and in the appended claims, the term “activated” means that the adhesive composition is capable of curing anaerobically in less than 24 hours, preferably in less than 4 hours, most preferably in an hour or less and of providing a fixture to mated surfaces within 2 hours, typically within 1, preferably within 15 minutes: fixture or a fixture cure being denoted by the presence of at least a weak bond between the mated substrates. Thus, while the adhesive composition, prior to activation, may have some anaerobic cure capability, especially when placed on an active surface, the rate and/or degree of cure is substantially less than that of the activated composition and, in any event, is insufficient to be of commercial use in high speed bonding and assembly operations. Additionally, as used herein and in the appended claims, the term “active” when referencing a surface or substrate means that there are naturally occurring compounds, radicals or ions, especially transition metal ions, present on or at the surface that initiate or accelerate free radical generation and/or anaerobic polymerization. Active surfaces typically include those of steel, brass, bronze, copper or iron. Conversely, “inactive” surfaces do not have such compounds, radicals and/or ions present and must typically be treated with a primer containing such constituents or materials capable of generating such constituents. Inactive surfaces typically include those of high-alloy steel, aluminum, nickel, zinc, tin, silver, gold, oxide films, chromate films, anodic coatings, plastics, ceramics, stainless steel, glass, and the like. Finally, as used herein and in the appended claims, the phrases “free radically polymerizable”, “anaerobically polymerizable” and “anaerobically curable” refer to the ability of the composition or component thereof to polymerize by free radical polymerization in the substantial absence of air or, more correctly, oxygen. These terms are used interchangeably herein with respect to the polymerizable monomers, oligomers and prepolymers as well as the adhesive formulations overall.

Anaerobically polymerizable compositions are well known and widely available. Exemplary of the anaerobically polymerizable compositions that can be modified for use in the practice of the present invention include those disclosed in, e.g., Krieble—U.S. Pat. No. 2,895;950; U.S. Pat. No. 3,041,322; U.S. Pat. No. 3,043,820; U.S. Pat. No. 3,203,941; U.S. Pat. No. 3,218,305; Bachman—U.S. Pat. No. 3,826,756; Malofsky—U.S. Pat. No. 3,855,040 and U.S. Pat. No. 4,007,323; Conway et. al.—U.S. Pat. No. 4,533,446; Toback et. al.—U.S. Pat. No. 3,591,438 and U.S. Pat. No. 3,625,930; Bich et. al.—U.S. Pat. No. 4,442,138; Lees—U.S. Pat. No. 3,658,624; Gorman et. al.—U.S. Pat. No. 3,300,547 and U.S. Pat. No. 3,425,988; Hauser et. al.—U.S. Pat. No. 3,970,505; Attarwala et. al.—U.S. Pat. No. 6,673,875 and U.S. Pat. No. 6,391,993; amongst others: all of which are hereby incorporated herein, in their entirety, by reference.

Anaerobically polymerizable compositions in accordance with the present invention are typically based upon acrylic ester monomers, dimers, oligomers, and/or pre-polymer systems or combinations thereof that are capable of anaerobic polymerization when in further combination with a peroxy polymerization initiator and, most preferably, in the presence of a transition metal ion. The present invention is especially applicable to di- and poly-acrylate esters; however, mono-acrylate esters can also be used in combination with the foregoing and/or if the non-acrylate portion of the monoacrylate ester contains a hydroxyl or amino group or other reactive substituent which serves as a site for potential cross-linking. Examples of suitable monoacrylate ester monomers include tetra hydrofurfuryl(meth)acrylate, cyclohexyl(meth)acrylate, isobutyl(meth)acrylate, hydroxyethyl(meth)acrylate, hydroxypropyl(meth)acrylate, cyanoethyl(meth)acrylate, t-butyl aminoethyl(meth)acrylate, dimethylaminoethyl(meth)acrylate and glycidyl(meth)acrylate.

Among the most preferable polyacrylate esters suitable for use in the practice of the present invention are those having the following general formula (I):

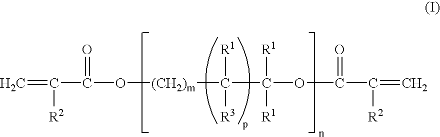

wherein each R¹ is independently hydrogen, a lower alkyl of 1 to 4 carbon atoms, or a hydroxyalkyl of from 1 to 4 carbon atoms and

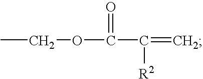

each R² is independently hydrogen, halogen, or a lower alkyl of 1 to 4 carbon atoms; each R³ is independently hydrogen, hydroxy or

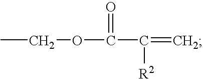

and m is an integer of at least 1, preferably from 1 to 15 or higher, and most preferably from 1 to 8 inclusive; n is an integer of at least 1, preferably from 1 to 20 or higher; and p is 0 or 1.

The polymerizable polyacrylates esters utilized in accordance with the invention and corresponding to the above general formula (I) are exemplified by, but not restricted to the following materials: diethylene glycol dimethacrylate, triethylene glycol dimethacrylate, tetraethylene glycol dimethacrylate, dipropylene glycol dimethacrylate, polyethylene glycol dimethacrylate, di(pentamethylene glycol)dimethacrylate, tetraethylene glycol diacrylate, tetraethylene glycol di(chloroacrylate), diglycerol diacrylate, diglycerol tetramethacrylate, tetramethylene dimethacrylate, ethylene dimethacrylate, neopentyl glycol diacrylate and trimethylol propane triacrylate. The foregoing monomers need not be in the pure state, but may comprise commercial grades in which stabilizers such as hydroquinones and quinones are included.

A second class of preferred acrylate esters are those that are formed by the reaction of an acrylate ester containing an active hydrogen atom in the alcoholic portion of the ester with an organic isocyanate. Preferably the active hydrogen is the hydrogen of a hydroxy or a primary or secondary amine substituent on the alcoholic portion of the ester, and the isocyanate is a di- or other polyisocyanate. Naturally an excess of the acrylate ester should be used to ensure that each isocyanate functional group in the polyisocyanate is substituted.

The most preferred of the acrylate esters used in the manner described above are those in which the acrylate ester is an alkyl or acyl acrylate ester, most preferably having the formula

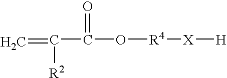

wherein X is selected from the group consisting of —O— and

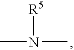

R⁵ is selected from the group consisting of hydrogen and alkyl or aralkyl of 1- to 10 carbon atoms; R² is as defined above, R⁴ is a divalent organic group selected from alkylene of 1 to 10 carbon atoms, ether linked polyalkylene of 1 to 12 carbon atoms and divalent aromatic groups containing up to 1-4 carbon atoms, preferably phenylene, biphenylene, and naphthalene.

Another class of useful oligomers and polymers are those acrylate capped compounds having one, and preferably, multiple urethane linkages in the backbone, in a ring, or pendant from the backbone. Such compounds are typically referred to, in the art, as urethane-acrylates. These can be conveniently prepared by reacting a diisocyanate and a combination of diols or polyols with an acrylate containing alcohol, such as hydroxypropyl methacrylate, or amine, such as 3-aminopropyl acrylate. Alternatively, they may be prepared by capping polyisocyanate/polyalkylene glycol prepolymers with acrylic functionality. Typical polyisocyanates which can be reacted with the above acrylate esters to form the urethane-acrylates are toluene diisocyanate, 4,4′-diphenyl diisocyanate, dianisidine diisocyanate, 1,5-naphthalene diisocyanate, trimethylene diisocyanate, cyclohexylene diisocyanate, 2-chloropropane diisocyanate, 4,4′-diphenymethane diisocyanate, 2,2′-diethyl ether diisocyanate, and 3-(dimethylamino)pentane diisocyanate. Still other polyisocyanates that may be used are the higher molecular weight polyisocyanates obtained by reacting an excess of any of the above-mentioned isocyanates with polyamines containing terminal, primary or secondary amine groups, or polyhydric alcohols, for example the alkane and alkene polyols such as glycerol, 1,2,6-hexanetriol, 1.5-pentanediol, ethylene glycol, polyethylene glycol, bisphenol-A, condensation products of alkylene oxides with bisphenol-A and the like. These and other suitable urethane-acrylate ester prepolymers are described in, for example, Gorman et. al. (U.S. Pat. No. 3,425,988) and Baccei (U.S. Pat. No. 4,018,851; U.S. Pat. No. 4,295,909; and U.S. Pat. No. 4,309,526), all of which are incorporated herein by reference.

Other suitable monomers useful in the present invention, not containing urethane linkages, include acrylate terminated epoxy or ester units, or low polymers thereof, especially those acrylates derived from bisphenol-A such as bisphenol-A di(meth)acrylate, hydrogenated bisphenol-A di(meth)acrylate and ethoxylated bisphenol-A di(meth)acrylate.

Another class of acrylate esters suitable for use in the present invention is the silicone acrylates as described in, e.g., Rich et. al.—U.S. Pat. No. 5,635,546 and Chu et. al.—U.S. Pat. No. 5,605,999, which are hereby incorporated herein by reference in their entirety.

Furthermore, any of the above-mentioned acrylate and polyacrylate ester monomers, dimers, oligomers and prepolymers may be used alone or in combination. Since many of the higher molecular weight acrylate esters described above are extremely viscous, it may be advantageous to employ a low viscosity acrylate ester, such as an alkyl acrylate ester, in combination therewith in order to reduce the overall viscosity of the curable composition.

As used herein and in the appended claims, the term “polymerizable acrylate ester monomer” is intended to include not only the pure and impure forms but also other compositions that contain those monomers in amounts sufficient to impart to the overall composition the anaerobic curing characteristics of the acrylate esters.

Typically, the anaerobically polymerizable component is present in the anaerobically polymerizable composition at a concentration of from about 50 to about 99.8 percent by weight, more preferably from about 85 to about 99 percent by weight, most preferably from about 90 to about 98 percent by weight, based on the combined weight of the adhesive formulation.

The second component of the activated anaerobic adhesive formulations of the present invention is the peroxy free-radical initiator. Suitable peroxy free-radical initiators are well known in the art and include any of a number of peroxides, especially hydroperoxides, and peresters. Suitable peresters include, for example, t-butyl peracetate, t-butyl peroxyisobutyrate, di-t-butyl di-perphthalate, t-butyl perbenzoate, 2,5-dimethyl-2,5-bis(benzoylperoxy)hexane and t-butyl maleic acid. Suitable peroxides include, for example, hydrogen peroxide; diacyl peroxides such as benzoyl peroxide; the dialkyl peroxides such as di-t-butyl peroxide; ketone peroxides such as methylethyl ketone hydroperoxide; hydroperoxides such as cumene hydroperoxide and tert-butyl hydroperoxide; and the organic peroxides described in Malofsky (U.S. Pat. No. 4,007,323), which is hereby incorporated herein by reference, in its entirety. Suitable hydroperoxides are also well known and are represented by the formula R⁶(OOH)_{z} wherein R⁶ is a hydrocarbon group containing up to 18 carbon atoms and z is 1, 2 or 3. Preferably z is 1 and R⁶ is an alkyl, aryl, or aralkyl hydrocarbon group containing from about 3 to about 12 carbon atoms. Naturally, R⁶ can contain any substituent or linkage that does not adversely interfere with the free radical generation. Exemplary hydroperoxides include cumene hydroperoxide, tertiary butyl hydroperoxide, methylethylketone hydroperoxide, p-methane hydroperoxide, diisopropyl benzene hydroperoxide, pinene hydroperoxide and the like. Combinations of peroxy initiators may also be used. Preferred peroxy initiators are the hydroperoxides, especially cumene hydroperoxide.

Those skilled in the art will readily recognize the need to be selective with respect to the choice of peroxy compounds when the formulation also contains a transition metal ion source, especially a metallocene such as ferrocene. Specifically, the instability of certain peroxides like benzoyl peroxide in the presence of ferrocene is well known. Thus, again, it is most preferable that the peroxy compound be a hydroperoxide, which are generally stable in the presence of such ferrocene compounds. In any event, the peroxy initiator is typically present at a concentration of from about 0.05 to about 10.0 percent by weight of the adhesive formulation and more preferably from about 0.3 to about 5.0 percent by weight of the adhesive formulation.

Optionally, though preferably, the UV activated anaerobic adhesive formulations of the present invention also contain a transition meal ion source, especially a source of copper or iron ions. Suitable source materials/additives for anaerobic compositions are well known. Preferred transition metal ions sources are the metallocene activators, i.e., those metallocenes or metallocene containing materials that, in the presence of the aforementioned free radical initiators, effectuate anaerobic polymerization of the acrylate ester monomers. Metallocenes are typically of three types, i) the dicyclopentadienyl-metals with the general formula (C₅H₅)₂M, ii) the dicyclopentadienyl metal halides of the formula (C₅H₅)₂MXₛ, where X is a halide, such as Cl or Br, and s is 1, 2 or 3; and iii) monocyclopentadienyl-metal compounds with the general formula C₅H₅MR⁷ₛ where s is as defined above and R⁷ is CO, NO, a halide group, an alkyl group, etc., and, in each instance, M is a transition metal, especially copper or iron, most preferably iron. Although the metailocene is preferably employed as the metallocene compound itself, the activator may also be in the form of polymers incorporating the metallocene and the acyl, alkyl, hydroxyalkyl and alkenyl derivatives of the metallocenes, preferably such derivatives having from 1 to 18, preferably from 1 to 8, carbon atoms, as well as combinations of any of the foregoing.

Suitable metallocenes include, ferrocene, n-butyl ferrocene, titanocene and cupricene. These and other metallocenes and their preparation are described in, e.g., Malofsky—U.S. Pat. No. 3,855,040, Wojciak—U.S. Pat. No. 4,093,556, and Rosenblum et. al.—U.S. Pat. No. 5,124,464, which are hereby incorporated herein, in their entirety, by reference. As noted above, the preferred activators are those metallocenes that are based on iron, especially ferrocene itself, as well as the various derivatives thereof, particularly butyl ferrocene.

Notwithstanding the “optional” reference above, when the activated anaerobically polymerizable composition is or is to be employed upon an inactive surface, i.e., one which is free or substantially free of transition metal ions, especially ferrocene or other activators which, in the presence of a strong acid react with peroxy initiators to produce free radicals capable of effecting anaerobic polymerization of the anaerobically polymerizable component, the ferrocene compound must be present. Typically, the transition metal ion source will be used at a concentration of from about 0.05 to about 10.0 percent by weight of the adhesive formulation and more preferably from about 0.2 to about 3.0 percent by weight of the adhesive formulation.

The final, key component of the activated anaerobically polymerizable compositions of the present invention is a strong acid, which, in the presence of the transition metal ion, reacts with the peroxy initiator to produce free radicals. Obviously, owing to the reactivity of the components, the strong acid is only present at the time of or following application of the adhesive composition to the substrate: otherwise, the composition would be too unstable for storage. Thus, in accordance with the present invention, and as a critical aspect of the present invention, the strong acid is generated in-situ immediately prior to, concurrent with or, preferably, following application to the substrate to be bonded. The strong acid is generated by or derives from a strong acid precursor present in the adhesive formulation as prepared upon exposure of the same to UV light. Strong acid precursors are known and include blocked acids which become unblocked upon exposure to UV light as well as photo-latent acid generators, i.e., compounds which decompose to form a strong acid upon exposure to UV light; however, it is important to avoid acid generators which also seem to interfere with free radical polymerization. The preferred strong acid precursors are of the type that decompose to form the strong acid and include a number of known sulfonium UV photoinitiators, especially the triarylsulfonium salts. On the other hand, though not intending to be bound by theory, it is best to avoid those onium compounds, like the iodonium salts, which are or, upon exposure to UV light, decompose to form strong acids that are thought to act as strong chain transfer agents inasmuch as these may capture free radicals, thereby interfering with or inhibiting free radical polymerization

Preferably the strong acid precursor is a triarylsulfonium salt or mixture of triarylsulfonium salts. These salts comprise at least one anion and at least one cation. The anion(s) can be any that balance the charge of the cation(s). Suitable anions include monatomic anions, such as chloride and iodide, and polyatomic anions, such as tetrafluoroborate, hexafluorophosphate, hexafluoroarsenate, and hexafluoroantimonate. Preferably, the anion is polyatomic. The cation(s) comprises one or more sulfur atoms, at least one of which is substituted with three aryl groups. Alternatively, the cation may comprise two triarylsulfonium structures bridged through a linking atom, especially a sulfur bridge. The aryl groups of the triarylsulfonium structures can be substituted or unsubstituted and can be the same or different. Preferred substitution includes alkyl groups such as methyl, especially in the para position, and thiophenoxy groups, especially the latter. Suitable cations include triphenylsulfonium, diphenyltolylsulfonium, diphenyl-(4-thiophenoxyphenyl)sulfonium and thiodi(triphenylsulfonium). Sulfonium salts of this kind are well known in the literature and have been prepared by a variety of means. (See, for example, U.S. Pat. No. 2,807,648; J. Am. Chem. Soc. 91, 145 (1969); and Bull. Soc. Chim. Belg; 73 546 (1964), all of which are hereby incorporated by reference in their entirety). Exemplary sulfonium salts include triphenylsulfonium tetrafluoroborate, triphenylsulfonium hexafluorophosphate, triphenylsulfonium hexafluoroantimonate, diphenyltolylsulfonium hexafluorophosphate, phenylditolylsulfonium hexafluoro-antimonate, diphenyl-(4-thiophenoxyphenyl)sulfonium hexafluoroantimonate, diphenyl-(4-thiophenoxyphenyl)sulfonium hexafluorophosphate, thiodi(triphenylsulfonium hexafluorophosphate) and thiodi(triphenylsulfonium hexafluoroantimonate) and mixtures of the foregoing. Suitable sulfonium salts are widely available. Especially preferred are the Cyracure® triarylsulfonium salts, including the Cyracure UVI-6976 and 6992 photoinitiators available from The Dow Chemical Company.

The amount of the strong acid precursor used in the preparation of the activated anaerobic adhesive compositions of the present invention will be from about 0.1 to about 15 percent, preferably from about 0.4 to about 10 percent, by weight of the adhesive formulation. Although these photoinitiators are typically cationic initiators, it is not believed that any or any substantial cationic polymerization of the curable components occurs. Instead, though not intending to be bound by theory, as noted above, it is believed that the short UV exposure and low energy absorption merely generate the strong acid which then participates in/initiates free radical generation.

Although the strong acid precursor is a critical component of the anaerobic compositions employed in the practice of the present invention, these compositions, prior to UV exposure, must be free or substantially free of acids or other acid generators/pre-cursors that will generate an acid under conditions of storage and transport. In essence, whatever acids or other acid precursors are present, if any, should be weakly acidic. Acids having a pKa or 3.5 or less, preferably a pKa of 5 or less must be avoided; otherwise, the formulations will be unstable.

The activated anaerobic adhesive compositions of the present invention may also contain, if desired, one or more conventional reactive diluents. Such reactive diluents are capable of copolymerizing with the anaerobically polymerizable component. Typical of such diluents are the hydroxyalkyl acrylates such as hydroxyethyl acrylate and hydroxypropyl acrylate and the corresponding methacrylates such as hydroxyethyl methacrylate and hydroxypropyl methacrylate.

The activated anaerobic adhesive compositions of the present invention may also contain conventional cure accelerators and co-accelerators such as aromatic and tertiary amines, hydrazines, and sulfimides. Suitable accelerators and co-accelerators are described in the above-referenced patent citations to anaerobically polymerizable compositions as well as in Bich et. al.—U.S. Pat. No. 4,442,138; Lees—U.S. Pat. No. 3,658,624; Toback—U.S. Pat. No. 3,625,930; and Hauser et. al.—U.S. Pat. No. 3,970,505, all of which are incorporated herein by reference in their entirety.

Optionally, the anaerobic adhesive formulations may also contain one or more adjuvants commonly used in the art, such as stabilizers, plasticizers, thickeners, dyes, thixotropes and chelating agents. Though the foregoing are optional, it is especially desired to include one or more, preferably a combination of, stabilizers to provide shelf and storage stability to the compositions prior to their activation or, more appropriately, intended activation. Several types of stabilizers are preferably employed in the compositions of the present invention including (i) free radical scavengers, (ii) UV absorbers, and (iii) acid scavengers: though it will be recognized that certain stabilizers fall into more than one of the aforementioned categories.

Suitable free radical scavengers include the quinones including β-naphthoquinone, 2-methoxy-1,4-naphthoquinone, p-benzoquinone and hydroquinones. These free radical scavengers are commonly used at levels of from about 0.01 to about 3.0 percent, preferably from about 0.05 to about 1.5 percent, by weight of the adhesive formulation.

Suitable UV absorbers are well known and include various benzophenones, especially hydroxybenzophenones such as 2,4-dihydroxy benzophenone, 2-hydroxy-4-methoxy-benzophenone, and 2-hydroxy-4-n-octoxy-benzophenone; benzotriazoles such as 2-(2′-hydroxy-5′-methyl phenyl)-benzotriazole, 2-(2′-hydroxy-5′-t-octylphenyl)-benzotriazole, 2-(2′-hydroxy-3′,5′-di-t-butylphenyl)-5-chloro-benzotriazole; hindered amines such as bis-(2,2,6,6-tetramethyl-4-piperidyl)-sebacate and poly{[6-[(1,1,3,3-tetramethylbutyl)amino]-s-triazine-2,4-diyl][(2,2,6,6-tetramethyl-4-piperidyl)imino]hexamethylene[(2,2,6,6-tetramethyl-4-piperidyl)imino]}; and combinations thereof. Preferably, the UV absorber is a benzophenone, especially a hydroxybenzophenone. The UV absorber is typically present at a concentration of from about 0.01 to about 3.0, preferably from about 0.05 to about 1.5 percent, by weight of the adhesive formulation.

Finally, the compositions of the present invention will preferably contain one or more suitable acid scavengers, particularly basic materials or reactive additives that will pick up or neutralize any tramp acids that may be present or arise from stray light. In particular, the acid scavenger is most preferably present if the formulation contains a transition metal or transition metal source, as described above. Exemplary acid scavengers include metal oxides, such as calcium oxide and magnesium oxide; phosphites, such as trisnonyl-phenylphosphite; metal carboxylates, such as calcium stearate, zinc stearate, and sodium benzoate; carbonates, such as sodium carbonate; anionic clays such as hydrotalcite; and various known acid scavenging epoxy materials including bisphenol-A epoxy resins and cycloaliphatic epoxy resins as well as various known acid scavenging monoepoxides. These acid scavengers are typically present at a concentration of from about 0.001 to about 10.0, preferably from about 0.05 to about 5 percent, by weight of the adhesive formulation. Obviously, the selection of the acid scavenger and the amount by which it is used will be such as not to scavenge too much of the strong acid generated by the UV exposure so as to interfere with or significantly retard free radical generation and, hence, polymerization or cure of the adhesive formulation.

Noticeably, however, the adhesive formulations, prior to activation, should be free of acidic constituents, especially those having at least moderate acidity as is often found with various adhesion promoters and the like. While such functional materials, i.e., impact modifiers, thickeners, thixotropes, etc., may be used, again, it is important to avoid those that are acidic in nature.

The adhesive formulations for use in preparing the activated anaerobically polymerizable adhesive compositions of the present invention may be prepared by any convention method for formulating adhesives provided that care is taken to ensure that the formulation, especially the strong acid precursor, is not exposed to any or any substantial amount of UV light. Once formulated, they are stored in suitable containers, especially ones that do not allow the transmission of UV light. For example, they may be stored in amber bottles or the like.

The activated anaerobically polymerizable adhesive compositions of the present invention are activated by exposing the same to UV light of sufficient intensity for a short period of time, generally up to about 20 seconds, more typically up to 5 seconds, immediately prior to, concurrent with or, preferably, following application of the formulation to the substrate to be bonded. Where activation occurs immediately prior to application or dispensing of the adhesive, a UV source is incorporated into the dispensing apparatus at or immediately preceding the dispenser nozzle outlet. Where activation occurs concurrent with the application or dispensing of the adhesive a UV source, which may be integrated into the dispensing apparatus or a separate apparatus itself, irradiates the adhesive formulation as it is exiting the dispenser nozzle and/or as it is falling or being applied to the substrate to be bonded. Most preferably, the adhesive formulation is activated after it has been applied to the substrate surface, either in the open state, before mating or following mating provided that at least one of the substrates is UV transparent. The latter allows for the adhesive to naturally spread (due to its low viscosity) or for the manual or automated spreading of the adhesive material to form a thin liquid film that is then irradiated with the UV light. Because of the relatively poor penetration of UV light into the adhesive, it is preferred that the liquid adhesive be in a thin film at the time of activation to ensure maximum activation, i.e., to ensure that all or the maximum possible amount of strong acid precursor is exposed to the UV light. Of course, the thickness of the film will also be dictated, in part, by the surfaces to be bonded, e.g., if a gap exists between the surfaces when mated, then film should be at least a thick as, if not thicker than, the gap.

As noted above, the exposure time may be up to about 20 seconds, typically up to 5 seconds, but is preferably much shorter, preferably less than about 2 seconds, most preferably less than a second. Indeed, for most high-speed industrial applications, exposure times of between about 0.01 to 1 second, more typically, from about 0.05 to 0.6, will enable excellent overall line speed so as to avoid the adhesive activation step from becoming a bottleneck in the overall manufacturing process. It is further contemplated that ultra-high speed assembly operations with high intensity lamps will allow even shorter exposure times of as little as 0.005 seconds, though the longer exposure times mentioned above are preferred.

Though Conway et. al. employed a similar process, as discussed above, they required much longer exposure times, generally from at least about a minute and a half up to four minutes. Even with two and three minute exposures at 7 mW/cm² (approximately 840 and 1260 mJ/cm² accumulated energy, respectively), little, if any, enhancement in cure/bond strength was attained as compared to that resulting from residual free radical cure caused by the inherent instability of these systems on an active surface, i.e., without any UV exposure.

Generally speaking, the activated anaerobic adhesive composition of the present invention may be activated by any commercial UV light source including high intensity lamps as well as fiber optic or flexible wand type sources. Preferred UV sources are those that provide 200-400 nanometer ultraviolet radiation. Depending upon the intensity of the UV source and distance of the UV source from the adhesive, the amount of energy available to the adhesive will vary. In following, these variables combined with the exposure time will affect the amount of energy consumed or accumulated by the adhesive composition during the activation thereof; however, each of these can be controlled to ensure proper activation. Generally, the energy available at the surface of the adhesive will be between about 20 and 1000 mW/cm², preferably from about 50 to about 500 mW/cm², most preferably from about 100 to about 300 mW/cm². However, as higher intensity sources are used, including those delivering more than 1000 mW/cm², the exposure time is shortened so as to avoid excess energy accumulation by the adhesive formulation. Furthermore, by properly associating the light source with the absorption characteristics of the UV activated strong acid precursor, one is able to further minimize and optimize the time and total energy exposure needed to effect a fast and complete cure. Those skilled in the art, in light of the teachings herein, will readily be able select the appropriate parameters for their particular UV source systems.

In commercial applications, especially high-speed industrial manufacturing and assembly operations, the UV Source is most preferably a high-intensity, medium-pressure mercury vapor lamp. The mercury lamp, often denoted as an H-bulb, has a widespread distribution of energy, but with strong emission in the short wavelength region. During activation the adhesive is exposed to the UV light in a continuous fashion. This can be conveniently done by use of a conveyer belt. By varying the speed of the conveyer belt, the amount of UV light exposure can be varied. Preferably, the belt is operated at a speed of from about 1 to about 300 meters per minute, more preferably from about 3 to about 100 meters per minute.

As noted earlier, the intensity or the UV light at the surface of the adhesive and the time of exposure will determine the amount of energy consumed or accumulated by the adhesive composition during activation. Generally speaking, it is desirable to keep the total energy available to or accumulated by the adhesive (through the full term of the exposure) to a level of below about 1000 mJ/cm², preferably less than about 800 mJ/cm², most preferably less than about 300 mJ/cm². A minimum accumulated energy of at least 1 mJ/cm², preferably at least about 10 mJ/cm², most preferably at least about 20 mJ/cm², will be required to provide good, especially short term cure capabilities. Of course, the amount of the strong acid precursor as well as the presence and amount of other UV absorbing materials, especially UV stabilizers, will affect the amount of energy to which the composition can be exposed/which the composition can absorb without adversely affecting cure performance and/or bond strengths. Thus, compositions with higher level of strong acid precursor and/or UV stabilizers will tolerate more UV energy than those having low levels of such constituents. Even so, it is preferred to keep the amount of activation energy available to/accumulated by the formulation within the ranges mentioned above.

The activated anaerobic adhesives, sealants and binder compositions of the present invention may be employed with any number of substrates, active and inactive, and in a myriad of applications. Suitable substrates include, but are not limited to, metals such as copper, steel, stainless steel, aluminum, nickel, zinc, tin, silver, and gold; oxide films; chromate films; anodic coatings; ceramics; glass; cellulosic materials such as paper and fiberboard; and plastics such as nylons, polyesters, and polyolefins. Additionally, these activated adhesive, sealant and binder compositions may be employed in bonding dissimilar materials such as one metal to another or one plastic to another as well as metals to plastics, paper to plastic, and the like. Similarly they may be used to form seals between such materials and substrates. Suitable applications include any bonding or sealing applications where anaerobic conditions are present; however, the present invention is especially suited for high-speed industrial bonding/sealing and assembly operations. Such applications include traditional bonding of one article or component thereof to another but are especially suited for bonding of one sheet material to a substrate or another sheet material as in, for example, the application of protective films to a substrate; the application of labels to a substrate, especially a container, or film, especially a packaging film; the preparation of laminates and/or the bonding of laminates to a substrate; the preparation of multi-layered films, especially plastic films, wherein one polymer film is adhered to another and/or to a metal foil; etc. Polymer films suitable for such applications include polyvinylchloride, polyvinylidene chloride, polyethylene, polypropylene, polyethylene terephthalate, and nylon. In following, by selection of appropriate materials, i.e., food grade approved materials, these adhesive may be used in food packaging applications for, for example, adhering labels to polymer films and/or for bonding a food packaging approved film to a non-food packaging approved film.

Another embodiment of the present invention relates to the combination of the activated anaerobic adhesive composition described above with another adhesive, sealant or binder composition, in a true dual cure/dual functional adhesive or sealant application. For example, the compositions of the present invention may be incorporated into various pressure sensitive adhesives, hot melt adhesives, and the like as taught in Doueck et. al. (U.S. Pat. No. 3,993,815), which is incorporated herein by reference. Both hot melt adhesives and pressure sensitive adhesives are conventional materials well known in the art and no detailed discussion is necessary. Essentially any known hot melt or pressure sensitive adhesive material, or other secondary adhesive systems, may be used so long as they are not moderately or strongly acidic nor contain a material that is or will generate a moderate or strong acid under the conditions of use of the secondary adhesive; unless, of course, it is intended to activate both adhesive systems concurrently. For example, in a binary adhesive system employing a hot melt and the anaerobic formulation it would be preferable that the heating of the hot melt adhesive to its application or activation temperature, especially in the case of reactive hot melts, not generate a strong acid. On the other hand, if the anaerobic formulation does not fixture fast enough for a given application and the hot melt is employed to provide a “temporary” fixture, it may be desirable to activate the anaerobic composition concurrently with the melting and application of the hot melt adhesive. The hot melt will then fixture the mated substrates while the anaerobic cure is achieved. Here the co-generation of acid may enhance free radical generation. Exemplary hot melt adhesives include those based on polyethylene, polypropylene, polyamide and polyester including, in particular, those based on ethylene vinylacetate copolymer and polycaprolactone. Also contemplated are reactive hot melts that undergo some measure of cross-linking during or subsequent to application. Similarly, exemplary pressure sensitive adhesives include those based on styrene-isoprene block copolymer, acrylic ester-vinyl acetate copolymers, ethylene-vinyl acetate copolymers, suitably plasticized vinyl acetate homopolymers, rubber-latex emulsion systems, and acrylic copolymers. Like the hot melts, the present invention is also applicable to those pressure sensitive adhesives that are generated in-situ whereby the tackiness is not prevalent, if even existent, until the composition is exposed to the proper activation conditions.

Alternatively, or in addition thereto, it is also contemplated that certain of the components, especially the polymerizable component of the anaerobic curable composition, may also comprise a part of or be involved in the cure of the second adhesive composition. For example, one or more of the acrylate ester components may further comprise a functional group that is not free radically polymerizable, but which is reactive with the cure mechanism of or co-reactive with another polymerizable component of the second cure system.

The amount of the UV activatable anaerobic composition to be combined with the second adhesive system depends upon what one's objective is. For example, if the purpose of the secondary adhesive is to provide a “temporary” fixture before activation of the UV activatable adhesive composition, one would use only so much of the secondary adhesive as is needed to achieve that temporary fixture. The temporary fixture would allow one to properly place/orient the substrates to be mated before activation of the anaerobic composition. This, of course, requires that one of the substrates be transparent to UV light so that activation can be attained. The use of low amounts of the secondary adhesive ensures a good temporary fixture with minimal impact upon the ultimate strength of the subsequently cured anaerobic adhesive. As used above, a “temporary” fixture means that a bond is formed but may be reversible and/or substantially weaker than the ultimate bond to be formed by the anaerobic composition. In these instances, the amount of the secondary adhesive system will comprise from about 1 to about 50 wt. %, preferably from about 2 to about 20 wt. % of the overall composition.

Alternatively, and surprisingly, it has been found that the addition of low amounts of the UV activatable anaerobic adhesive composition of the present invention to a second adhesive composition, especially hot melt and pressure sensitive adhesives provides added strength and improved properties to the latter. Not wishing to be bound by theory; however, it is believed that the UV activatable adhesive, when cured, forms an interpenetrating network of the cure acrylic ester composition throughout the matrix of the secondary adhesive system in which it is incorporated. As a result, the effective melt temperature of the hot melts is increased, i.e., higher temperatures are needed to reverse the bond. Whether this phenomenon is as a result of a change in the actual melt temperature of the hot melt adhesive or as a result of either the generation of anaerobic bonds across the bond interface and/or the restricted flow of the holt melt due to the presence of the interpenetrating network is unknown. But it nevertheless is manifested.

Similarly, in pressure sensitive adhesives, the presence of the cured anaerobic adhesive increases the strength of the adhesive bond and/or retards or prevents creep. It also alters the solubility of the PSAs; thus, again, increasing the end-use applications to which they may be applied.

Typically, where the objective is to use the anaerobic adhesive to modify the characteristics of the secondary adhesive, the UV activated anaerobically curable compositions of the present invention will comprise at least about 2 wt. %, preferably at least about 10 wt. %, most preferably at least about 25 wt. % of the overall composition. Generally, there is no upper limit, though, as noted above, as one increases the ratio of the anaerobic adhesive to the secondary adhesive, there will be a transition wherein the former will become the matrix with discrete domains and/or interpenetrating networks of the secondary adhesive therein.

The dual systems of the present invention may be made by any conventional manner know to those skilled in the art. For example, liquid systems may be blended by simple mixing equipment. Where incompatibility is of concern or where one or more of the component of either adhesive is a solid, especially, e.g., in the case of in-situ generated PSAs and the like, appropriate solvents may be employed so as to make the mixing easier. Finally, in the case of hot melts, typically the UV activatable adhesive will be added to the hot melt in its molten state.

The adhesive formulations of the present invention may be applied to the substrate using any of the known methods, especially as known for the particular application and substrate. Typically, the surface to be bonded will have a continuous layer of the adhesive formulation applied thereto. Preferably, the adhesive will be present as a substantially uniform thin layer having a thickness of less than 500 microns, more preferably, less than 1.00 microns. Suitable coating methods include brush coating, spray coating, dip coating, meniscus coating, transfer coating, roller coating, reverse roll coating, gravure coating, die extrusion coating, rotary screen printing, flexo printing, doctor blade coating, and the like. Transfer roll coating is especially desirable for large scale applications to films and the like, especially where thin films (around 0.1 mil or less) of the liquid adhesive are desired to be deposited. The speed of the continuous coating process can be varied, but generally faster speeds are preferred. Preferably, the coating is applied at a rate greater than 0.5 meter per minute, more preferably, greater than 1 meter per minute.

One preferred coating method is to meter the anaerobic adhesive formulation: in this respect, any system capable of coating in a thin layer can be used. Suitable techniques to set the thickness include the use of a doctor blade or a Meyer rod. Meyer rods are preferred and are well known in the art. Typical Meyer rods comprise a cylindrical rod with wire wrapped tightly around its circumference across substantially the entire length of the rod. The amount of adhesive that a given Meyer rod will leave on a substrate surface is essentially determined by the space between adjacent wires, more accurately, the space between the exposed curvatures of adjacent windings. This spacing is dependent upon the wire diameter or gauge: a smaller gauge wire will result in a thinner film of adhesive and, thus, less adhesive overall. Specifically, during application of the adhesive, the adhesive is applied to the substrate and the Meyer rod passed over the coated surface to squeegee off, i.e., meter, excess adhesive so that only that amount of adhesive which passes beneath the Meyer rod (and between the wires) is left on the surface of the substrate to be bonded. Essentially any Meyer rod is suitable for use in the present invention. Those, skilled in the art will readily select the appropriate Meyer rod needed in order to obtain the coating thickness desired or needed for their specific application.

As discussed above, the activated anaerobic adhesive formulations of the present invention are created by exposing the adhesive formulation containing the strong acid precursor to UV light for up to 20 seconds, more typically up to 5 seconds. While, as also noted above, activation may occur immediately prior to or concurrent with application of the adhesive, it is preferred that activation occur once the adhesive has been applied to the substrate surface and, if applicable, metered or spread into a thin film. This is especially beneficial in order to ensure sufficient activation in high-speed bonding applications.

Once activated, the anaerobic formulations remain fairly stable (though stability can be enhanced by the addition of suitable stabilizers) but will cure fairly rapidly once anaerobic conditions are created, i.e., once air or oxygen is excluded, as for example when a second substrate is mated with the first. Though immediate use seems optimal, the relative stability of the activated compositions provides for good open times so that the substrate with the activated anaerobic adhesive can undergo further operations/processes before it is mated with the second substrate. Additionally, these long open times allow one to design or retrofit one's automated assembly and manufacturing apparatus in a way that the adhesive application and activation station may be inserted at a convenient point in the overall industrial assembly apparatus rather one that immediately precedes the bonding or mating station. Notwithstanding the general stability of these activated systems, because of oxygen inhibition and the consumption of free radical source, open time should be limited to as short as possible, preferably less than 2 hours, most preferably less than an hour. This, however, should not be an issue in manufacturing operations as such open times would be inconsistent with the ultimate goal of high through-put in manufacturing operations.

Although the adhesive systems of the present invention seem to be substantially insensitive to or unaffected by the length of open time, most applications would suggest that it may be desirable or beneficial to keep open times to a minimum so as to avoid the possibility of dust, particles, and other extraneous matter present in the workspace from contaminating the activated adhesive composition. For example, laminates of clear plastic films or glass sheets may be deemed out-of-spec should dirt and other visible debris become trapped in the laminate structure. Similarly, the mating of low tolerance, zero gap metal components may fail to bond and/or will be deemed out-of-spec if particulate matter that bridges or has a particle size larger than the intended gap becomes trapped between the mated surfaces.

Finally, the last step in the process of bonding using the activated anaerobic adhesives of the present invention is the actual mating of the substrate surface containing the activated adhesive with the other surface and/or substrate to which it is to be boned. This mating process substantially excludes air from reaching the activated anaerobic adhesive, thereby allowing the anaerobic adhesive formulation to cure and adhere the surfaces together. Should either or both substrates be oxygen permeable, it will be necessary to create an anaerobic environment for sufficient cure or polymerization to occur. For example, the assembly may be placed in a chamber or other vessel, bag or the like, and the oxygen atmosphere removed or an oxygen free atmosphere generated. Alternatively, the conditions of storage or manufacture may induce anaerobic conditions. For example, in the case of the formation of laminate films, the winding or taking up of the multi-layered film on a large roll will create anaerobic conditions for the inner windings as oxygen will be unable to penetrate through the depth of the film roll but, perhaps for the outermost windings.

Alternatively, and as a means to avoid some of the problems with open times, such as contamination, it may be preferable to immediately mate the substrates to be bonded following application of the adhesive composition, but prior to exposure to the UV light, provided that at least one of the substrates being mated is transparent to UV light. By “transparency” is meant that the substrate will allow sufficient UV light to penetrate through the substrate as to enable the generation of the strong acid from the strong acid precursor in the anaerobic formulation. Here, so long as the mated substrates create an anaerobic environment at the bond interface, anaerobic polymerization or cure will commence upon UV exposure. Alternatively, if one or both substrates are also oxygen permeable, then polymerization or cure will not occur, at least not at a sufficient rate unless and until anaerobic conditions are presented.

Regardless of how or when activation and anaerobic conditions are achieved, in accordance with the present invention, the adhesive formulations will be essentially fully cured within 24 hours, preferably within 4 hours. More importantly, these activated anaerobic adhesives will fixture, though bond strength may not be fully developed, within 2 hours. Typical fixture times are less than 1 hour, preferably less than 15 minutes, and more preferably less than 2 minutes.

Obviously, the edges of the adhesive composition sandwiched between the mated surfaces will still be exposed to air and, therefore, cure at the exposed surface may be inhibited. Despite the uncured surface materials, for the purpose of this specification, these compositions are deemed cured. Regardless, there may be applications where complete cure is necessary, for example in those applications where there is concern for the aesthetic appearance of the adhesive or bonded assembly. Here, in the absence of full cure, the wet adhesive surface will attract and trap dirt, dust and the like and be quite noticeable. A number of alternatives exist for effecting full cure or avoiding the problems. For example, it may be desirable to seal, temporarily or permanently, these edge regions or, if feasible, place the entire assembly in an anaerobic environment so as to exclude air and thereby allow the same to cure. Alternatively, the edge regions may be wiped clean of any uncured materials. Yet another alternative is the incorporation of a secondary cure mechanism whereby curatives and/or other curable/polymerizable components are incorporated into the adhesive formulation which are responsive to other than anaerobic conditions, e.g., humidity, heat, light, etc. Here, the secondary or dual cure mechanism preferably arises from the incorporation of a second curative for the anaerobically polymerizable components. Dual cure adhesive and sealant compositions, i.e., those incorporating a secondary cure mechanism, are well known in the art and are disclosed in numerous patent publications including, for example, Attarwala et. al., U.S. Pat. No. 6,883,413; Palazzotto et. al. U.S. Pat. No. 5,376,428; Lautenschlaaeger et. al. U.S. Pat. No. 5,234,730; Chu et. al. U.S. Pat. No. 5,516,812; Bradford et. al. U.S. Pat. No. 6,835,759, all of which are incorporated herein.

The following examples merely illustrate the invention. Those skilled in the art will recognize many variations that are within the spirit of the invention and scope of the claims. With the exception of those samples cured with a point light source, as indicated below, all samples were cured by passing the pre-activated adhesive through a Hanovia UV 6 curing unit having a 300 W H-bulb. Unless otherwise indicated, the lamp was approximately 3.75 inches from the samples being irradiated.

Similarly, unless otherwise indicated, all formulations were prepared by mixing the various constituents in a polyethylene container in the following sequence: acrylic esters, ferrocene compound, photoinitiator/strong acid precursor and peroxide. In the first step the acrylic ester(s) were weighed in the polyethylene container and covered if necessary. Before each subsequent constituent was added, the contents of the container were mixed by one of three methods, as follows: processing for one cycle on a centrifuge mixer, mixing for about one minute with an impeller or mixing for about 10 minutes with a magnetic stirrer. In the case of the ferrocene compound, if it was a solid, it was fully dissolved before the mixing step. The prepared formulations were placed in a dark amber container and stored in a dark, cool place.

Finally, Table 1 sets forth the cure scale employed in evaluating the cure characteristics or properties for Examples 7 and higher. Since adhesive remains uncured along the edges of the adhesive due to oxygen inhibition, a rating of 9.9 is applied to those compositions that are deemed fully cured but for the exposed adhesive edge surfaces.

### EXAMPLE 1

An anaerobic adhesive formulation was prepared by mixing in order the following ingredients in the following parts by weight: 8.4 parts aliphatic urethane hexaacrylate (an acrylate capped aliphatic urethane available as Ebecryl® 1290 from Cytec Industries Inc.); 15.25 parts methoxy polyethylene glycol 550 monomethacrylate (a Monofunctional methoxylated polyethylene glycol methacrylate capped monomer available

TABLE 1

| Scale | Cure Characteristics |
|---|---|
| 0 | No cure |
| 1 | Minor thickening, only capillary attraction |
| 2 | Moderate thickening, only capillary attraction |
| 3 | No fixture, viscosity above 200K, some gelled or cured areas, |
| | particularly in the center of exposed region |
| 4 | No fixture, viscosity above 1M, some gelled or cured areas, |
| | particularly in the center of exposed region |
| 5 | No fixture, viscosity above_M; some gelled or cured areas, |
| | particularly in the center of exposed region |
| 6 | Fixture cure, substrates move under light pressure |
| 7 | Fixture cure, substrates move under moderate pressure |
| 8 | Fixture cure, substrates move under firm pressure |
| 9 | Fixture cure, odor, occasional glass break |
| 10 | Full cure, no odor, glass usually breaks under pressure |
| gel | Substantial gelation, though surface still wet |

as CD-552 from Sartomer Company Inc.); 0.10 parts butyl ferrocene; 0.25 parts of a mixture of triaryisulfonium hexafluorophosphate salts in propylene carbonate (available as UVI-6992 from Dow Chemical Company); and 0.12 parts cumene hydroperoxide. With the addition of each ingredient, the formulation was mixed. A polyester film having a thickness of 180 microns was coated with the formulation using a Meyer rod. The coated film was run continuously through a Hanovia UV 6 curing unit at a speed of 30 meters per minute. This gave an exposure time of 0.3 second and an accumulated energy exposure of 27 mJ/cm². Thereafter, a second polyester film was placed over a portion of the activated coated surface and the adhesive allowed to cure. Shortly after applying the second film, good adhesion was observed between the two polyester surfaces. In areas where no second surface was applied, the formulation remained uncured.

### EXAMPLE 2

A similar formulation was prepared by adding an additional 0.5 parts by weight of cumene hydroperoxide to 22.45 parts by weight of the adhesive composition of Example 1. The adhesive composition was used to prepare a polyester laminate, as in Example 1. It was found that the cure speed of the activated anaerobic adhesive in the covered areas had been increased by the increase in the level of cumene hydroperoxide.

### EXAMPLE 3

Again, a similar formulation was prepared, this time by adding an additional 0.3 parts by weight of butyl ferrocene to the adhesive composition of addition of Example 2. This adhesive composition was also used to prepare a polyester laminate, as in Example 1. It was found that the cure speed of the activated anaerobic adhesive in the covered areas had been further increased by the increase in the level of butyl ferrocene.

### EXAMPLES 4 AND 5

Two anaerobic adhesive formulations were prepared by mixing in order the following ingredients in parts by weight: 23.65 parts SR 348—ethoxylated bisphenol-A dimethacrylate (Sartomer Company, Inc.), 0.35 parts ferrocene (Example 4) or butyl ferrocene (Example 5), 0.8 parts UVI 6992 photoinitiator and 0.6 parts cumene hydroperoxide. Polyester laminates were prepared as in Example 1 and the structures allowed to stand overnight. The following day it was found that the adhesive in the covered areas had fully cured while the exposed, uncovered areas had not.

### EXAMPLE 6 AND COMPARATIVE EXAMPLES 1 AND 2

An anaerobic adhesive formulation, similar to that of Example 1, was prepared except that the amounts of the constituents varied. In this example the formulation contained, in parts by weight, 8.4 parts Ebecryl 1290, 15.25 parts CD 552, 0.35 parts butyl ferrocene, 0.8 parts UVI 6992 and 0.6 parts cumene hydroperoxide. The formulation was applied to three pieces of the polyester film and activated by passing the same through the Hanovia UV 6 curing unit at three different speeds, 15 ft/minute (Comparative Example 1), 30 ft/minute (Comparative Example 2) and 75 ft/minute (Example 6). The adhesive compositions of both Comparative Example 1 and Comparative Example 2 had fully cured before the film had exited the UV curing unit. On the other hand, the adhesive composition of Example 6 was still wet upon exiting the UV curing unit and cured once a second piece of polyester film had been laid over the activated adhesive.

### COMPARATIVE EXAMPLE 3

An anaerobic adhesive formulation was prepared containing the following constituents, in parts by weight: 8.4 parts Ebecryl 1290, 15.25 parts CD 552, 0.24 parts butyl ferrocene, 0.72 parts Irgacure 250—(4-methylphenyl)-[4-(2-methylproplyl)phenyl iodonium hexafluorophosphate salts (Ciba Specialty Chemicals) and 0.41 parts cumene hydroperoxide. The formulation was applied to pieces of the 7 mil polyester film and activated by passing the same through the Hanovia UV 6 curing unit at different speeds. At 15 ft/minute, the formulation had fully cured before the sample had exited the UV curing unit. At 30 ft/minute, the formulation had partially cured prior to exiting the UV curing unit and failed to cure further once a second piece of polyester film was laid over the UV exposed adhesive. At 45 ft/minute and higher speeds, there was no apparent cure in the UV curing unit; however, these systems also failed to cure when a second piece of polyester film was laid over the UV exposed adhesive. This shows the inapplicability of iodonium salts in the practice of the present invention.

### EXAMPLES 7-36

A series of anaerobic adhesive formulations, Formulations A through G, were prepared having the formulations set forth in Table 2, all amounts are in parts by weight. A small quantity, about 1 drop, of each of these formulations was then applied to 3″ by 6″ piece of Mylar polyester film and drawn down to cover an area of about 2″ by 4″ at thickness of about 25 mils. The samples were then exposed to UV light at varying intensities and for varying durations, the duration being adjusted by varying the speed of the conveyor through the Hanovia 6 UV curing unit. Following UV exposure, a second piece of the Mylar polyester film was laid over the UV exposed adhesive composition and allowed to cure and the degree of cure evaluated. The actual formulations, exposure conditions and performance results are presented in Table 3.

TABLE 2

| | Formulation | | | | | | | |
|---|---|---|---|---|---|---|---|---|
| Component | A | B | C | D | E | F | G | H |
| Ebecryl 1290^{a} | 16.6 | 16.6 | 17.0 | 8.3 | 4.0 | 16.6 | 16.6 | |
| SR 348^{b} | 20.0 | 16.0 | 20.0 | 8.0 | 3.85 | 20.0 | 20.0 | |
| SR 351^{c} | 10.0 | 10.0 | 10.0 | 5.0 | 2.4 | 10.0 | 10.0 | |
| SR 610^{d} | | | | | | | | 36.6 |
| CN 965^{e} | | | | | | | | 10.0 |
| n-butyl | 0.7 | 0.7 | 0.7 | 0.35 | 0.5 | 0.7 | 0.7 | 0.7 |
| ferrocene | | | | | | | | |
| Cumene | 1.2 | 1.2 | 1.2 | 1.8 | 0.85 | 1.2 | 1.2 | 1.2 |
| hydroperoxide | | | | | | | | |
| UVI 6976^{f} | | | | | | | 1.5 | 1.5 |
| UVI 6992^{g} | 1.5 | 4.5 | 0.2 | 2.25 | 1.1 | | | |
| Irgacure 250^{h} | | | | | | 1.5 | | |

^{a}aliphatic urethane hexaacrylate (Cytec Industries Inc.)
^{b}ethoxylated bisphenol-A dimethacrylate (Sartomer Company, Inc.)
^{c}trimethylolpropane triacrylate (Sartomer Company, Inc.)
^{d}polyethylene glycol diacrylate (Sartomer Company, Inc.)
^{e}urethane acrylate (Sartomer Company, Inc.)
^{f}mixed triarylsulfonium hexafluoroantimonate salts (The Dow Chemical Company)
^{g}mixed triarylsulfonium-hexafluorophosphate salts (The Dow Chemical Company)
^{h}(4-methylphenyl)-[4-(2-methylproplyl)phenyl] iodonium hexafluorophosphate salt (Ciba Specialty Chemicals)

Based on the results presented in Table 3, it is evident that activation longer exposure times and, thus, higher energy accumulation is undesirable and results in anaerobically curable compositions having less desirable cure characteristics. This is especially evident from Examples 7-12 and 33-36. Examples 19-24 demonstrate the effect of low levels of the strong acid precursor on cure performance of the activated anaerobically curable adhesives while Examples 13-18 demonstrate that higher levels of the acid precursor will tolerate longer exposure times and higher energy levels. Consistent with Comparative Example 3 above, Examples 29 and 30 once again demonstrate the relatively poor performance manifested by the use of an iodonium salt acid precursor. Finally, some color change and viscosity increase was noted with Formulations D, E and F when left to sit overnight, presumably due to the presence of tramp acids. However, inasmuch as

TABLE 3

| | | | UV | Accu- | Cure | |
|---|---|---|---|---|---|---|
| | Adhesive | Exposure | Source | mulated | Characteristics | |
| | For- | Time | mW/ | Energy | 15 | 24 |
| Example | mulation | (seconds) | cm² | mJ/cm² | Minutes | Hours |
| 7 | A | 0.17 | 125 | 21 | 9.5 | |
| 8 | A | 0.17 | 300 | 50 | 9.5 | |
| 9 | A | 0.6 | 125 | 75 | 9.5 | |
| 10 | A | 0.6 | 300 | 180 | 9.9 | |
| 11 | A | 2.0 | 125 | 250 | 3 | |
| 12 | A | 2.0 | 300 | 600 | 3 | |
| 13 | B | 0.2 | 125 | 25 | 9.9 | 9.9 |
| 14 | B | 0.2 | 300 | 60 | 9.5 | |
| 15 | B | 0.6 | 125 | 75 | 9.9 | |
| 16 | B | 0.6 | 300 | 180 | 9.9 | |
| 17 | B | 2.0 | 125 | 250 | <7 | |
| 18 | B | 2.0 | 300 | 600 | 9.0 | |
| 19 | C | 0.2 | 125 | 25 | 2 | |
| 20 | C | 0.2 | 300 | 60 | 7.5 | |
| 21 | C | 0.6 | 125 | 75 | <4 | |
| 22 | C | 0.6 | 300 | 180 | >4 | |
| 23 | C | 2.0 | 125 | 250 | <1.5 | |
| 24 | C | 2.0 | 300 | 600 | 7 | |
| 25 | D | 0.2 | 125 | 25 | >9.5 | 9.9 |
| 26 | D | 0.2 | 300 | 60 | >9.5 | |
| 27 | E | 0.2 | 125 | 25 | 9.9 | 9.9 |
| 28 | E | 0.2 | 300 | 60 | 9.9 | |
| 29 | F | 0.2 | 125 | 25 | 4 | 8 |
| 30 | F | 0.2 | 300 | 60 | 6 | |
| 31 | G | 0.2 | 125 | 25 | 9.9 | 9.9 |
| 32 | G | 0.2 | 300 | 60 | 9.9 | |
| 33 | H | 0.2 | 125 | 25 | 9.9 | 9.9 |
| 34 | H | 0.2 | 300 | 60 | 9.9 | |
| 35 | H | 2.0 | 125 | 250 | 0 | |
| 36 | H | 2.0 | 300 | 600 | 0 | |

these formulations were not stabilized, it is believed that these issues can be readily addressed by incorporating conventional stabilizers in conventional amounts.

In general, these results demonstrate that an activated anaerobically polymerizable composition having excellent cure speeds and cure characteristics can be achieved by exposing a precursor anaerobic adhesive formulation containing a strong acid precursor to UV light for extremely short periods of time. These activation parameters render the adhesive compositions suitable for high-speed industrial bonding and assembly operations.

### EXAMPLE 37

Formulation A from the preceding examples was employed to evaluate bonding characteristics on two different substrates, glass slides and aluminum lap shears. The samples were prepared by placing a dot of the adhesive, approximately 0.05 g, towards one end of the substrate and spreading the same to form a thin film of the adhesive. The adhesive was then exposed to UV light of the intensity and times indicated using a handheld, fiber optic UV source (the Model 100 Wand unit available from Synchron, Inc., 683 N. Mountain Rd., Newington, Conn. 06111) held approximately 1.5 inches above the sample. A second similar substrate was then immediately laid over the first so as to provide a 0.75 inch overlap. The conditions and results obtain were as presented in Table 4.

TABLE 4

| | | | Estimated | |
|---|---|---|---|---|
| | UV intensity | Exposure | Accumulated | |
| | at source | Time | Energy | Cure Speed |
| Substrate | mW/cm² | (seconds) | mJ/cm² | (seconds) |
| Glass | 2500 | 0.3 | 22.5 | <15 |
| Glass | 4500 | 0.3 | 40.5 | <10 |
| Aluminum | 2500 | 0.2 | 15 | <20 |
| Aluminum | 4500 | 0.2 | 27 | <15 |
| Aluminum | 2500 | 2 | 150 | 600 |
| Aluminum | 2500 | 3 | 225 | * |
| Aluminum | 2500 | 4 | 300 | * |

* subsurface cure but still bondable

### EXAMPLES 38-49

Two formulations, Formulations I and J, were prepared for evaluation of the cure speed following various exposures to UV light. The specific formulations were as presented in Table 5. In these examples a dot of the adhesive, approximately 0.1 g, was applied to a glass slide and another glass slide pressed (but not left) against the dot to spread the adhesive into a 0.5 inch circle. The adhesive was then exposed to UV light of the intensity and times indicated using the fiber optic UV source of the preceding example. Following activation, a second slide was laid over the first and secured in place by use of a small clap. The assemblies were allowed to stand for the time indicated before the samples were evaluated to determine the degree of cure. The specific samples and the results are presented in Table 6.

TABLE 5

Formulation

| Component | I | J |
|---|---|---|
| Ebecryl 1290^{a} | 8.25 | |
| SR 454^{b} | 15.2 | |
| CN 983^{c} | | 20 |
| Hydroxypropyl methacrylate | | 8 |
| Ferrocene | 0.18 | 0.38 |
| Cumene hydroperoxide | 0.62 | 0.62 |
| UVI 6976^{f} | | |
| UVI 6992^{g} | 0.75 | 0.75 |

^{a}aliphatic urethane hexaacrylate (Cytec Industries Inc.)
^{b}ethoxylated trimethylolpropane triacrylate (Sartomer Company, Inc.)
^{c}urethane acrylate (Sartomer Company, Inc.)
^{f}mixed triarylsulfonium hexafluoroantimonate salts (The Dow Chemical Company)
^{g}mixed triarylsulfonium hexafluorophosphate salts (The Dow Chemical Company)

The results shown in Table 6 confirm the fast and excellent cure characteristics of the activated anaerobically polymerizable compositions of the present invention. A comparison of Examples 38-40 with Examples 41-43 shown the impact insufficient/too short UV light exposure has on performance.

TABLE 6

| | | Distance | | | | | | | | | | | | | |
|---|---|---|---|---|---|---|---|---|---|---|---|---|---|---|---|
| | | From | Exposure | Estimated | | | | | | | | | | | |
| | | Source | Time | Energy | Cure Time (Minutes) | | | | | | | | | | |
| Example | Formulation | (inches) | (seconds) | MJ/cm² | 1 | 2 | 5 | 10 | 15 | 20 | 30 | 40 | 60 | 120 | 1440 |
| 38 | I | 1.5 | 0.2 | 15 | 4 | 4.5 | 4.5 | 4.5 | 5 | 5.5 | 7 | 8 | >9.5 | >9.5 | >9.5 |
| 39 | I | 1.5 | 0.3 | 23 | 4 | 6.5 | 7 | 7.5 | 9.5 | >9.5 | >9.5 | >9.5 | >9.5 | >9.5 | >9.5 |
| 40 | I | 1.5 | 0.5 | 38 | gel | gel | gel | gel | gel | gel | gel | gel | gel | gel | gel |
| 41 | I | 3.5 | 0.3 | <4 | | | | | | | | | | 2.5 | |
| 42 | I | 3.5 | 0.5 | <6 | | | | | | | | | | >3.5 | |
| 43 | I | 3.5 | 1.0 | <13 | | 3.5 | | 4.5 | 5.5 | | >6.0 | | >9.5 | | >9.5 |
| 44 | J | 1.5 | 0.2 | 15 | | | | | 4 | >5.0 | >5.0 | | | | >9.5 |
| 45 | J | 1.5 | 0.3 | 23 | 4.5 | 4.5 | 5 | 5 | 5.5 | >5.5 | >5.5 | >5.5 | >5.5 | >9.5 | >9.5 |
| 47 | J | 1.5 | 0.5 | 38 | 4 | 4 | 4.5 | 4.5 | 6.5 | 6.5 | 7.5 | 7.5 | 8 | >9.5 | >9.5 |
| 48 | J | 1.5 | 0.7 | 53 | | | | | 5.5 | 8 | 9 | | | | >9.5 |

### EXAMPLES 49-51

A further set of samples were prepared using Formulation I on glass slides as set forth in the preceding set of Examples except this time the second glass slide was left in place following the spreading of the adhesive formulation. The assembly with the adhesive sandwiched between the two glass slides was then exposed to fiber optic UV light source, 2.5 W/cm², at a 1.5 inch distance, for three different periods of time, 0.5, 0.8 and 1.0 seconds. The degree of cure was then assessed, using the Cure Scale first mentioned above, after two minutes. The results are shown in Table 7.

TABLE 7

| | Exposure | Accumulated | |
|---|---|---|---|
| | Time | Energy | Cure |
| Example | (seconds) | mJ/cm² | Characteristics |
| 49 | 0.5 | 38 | 4 |
| 50 | 0.8 | 45 | 8 |
| 51 | 1.0 | 75 | 9 |

The results of these examples demonstrate the excellent performance and versatility of the activated anaerobically polymerizable adhesives of the present invention. Specifically, these examples demonstrate that activation may, if desired, be effected subsequent to the assembly of the components or substrates to be bonded where at least one of the substrates is substantially transparent to UV light. Such substrates include non-UV blocking glass and transparent polymer films and sheets.

This aspect of the present invention enables one to employ anaerobic adhesives in what would normally be considered anaerobic conditions, without concern of bonding. Bonding is effected or at least initiated at a later time, i.e., when subjected to UV exposure. The many attributes of this circumstance include allowing the assembly to be manipulated before bonding: a feature which may be especially important in applications where precise mating is required and such precision is difficult to attain without subsequent manipulation. It also allows one to over the adhesive material, thereby preventing possible contamination with airborne and other extraneous matter before cure or bonding is desired. Finally, should activation have been incomplete or insufficient to ensure full cure of the adhesive, one may subject the assembly to a subsequent, further irradiation step to ensure full cure. For example, if the UV light source in an automated assembly operation, for whatever reason, fail to work or not work at its intended intensity, the uncured or partially cured assembly could merely be passed by another UV light source or the same if it is returned to proper working order, to complete the cure and bonding operation.

### EXAMPLE 52

A series of samples were prepared for assessing the residual or background anaerobic activity of the adhesive formulations used in the practice of the present invention. A drop of Formulations I and J was applied to a plurality of glass slides and acetone washed, sand blasted, cold rolled steel lap shears. The adhesive was spread over the tail 1 inch section of each lap shear or glass slide to a thickness of about 5 mils. In the case of the glass slides and one set of steel lap shears, the same were immediately mated with a like slide or lap shear, as appropriate, in a manner so that the two substrates overlapped by about an inch: the area of overlap corresponding to the area of the one substrate having the adhesive applied thereto. No UV exposure was provided. Three additional sets of the steel lap shears having the adhesive applied to their surfaces were then exposed to UV light, one set for 0.3 seconds and the remaining two sets for 0.7 seconds, using the abovementioned fiber optic UV source at a distance of 1.5 inches. Immediately following. UV exposure, a second steel lap shear was laid over the exposed adhesive of the first set and one of the second sets and the two substrates mated so as to provide the same 1 inch overlap. The remaining set of steel lap shears was allowed to stand for 10 minutes before the second steel lap shear was applied, again to provide the 1 inch overlap. Each set of steel lap shears and the glass slides were allowed to sit for 24 hours before being tested on an Instron Tensile Shear Testing machine. The results of these tests are presented in Table 8.

The results show that these systems, prior to activation, are quite stable (no cure on glass); though they do experience residual/-background activity when applied to active substrates under anaerobic conditions (low cure on steel lap shears). However, the amount of cure is insignificant, particularly as compared to the UV activated compositions of the present invention.

TABLE 8

| | | | Estimated | | |
|---|---|---|---|---|---|
| | | Exposure | Accumulated | Open | Tensile |
| | | Time | Energy | Time | Strength |
| Formulation | Substrate | (seconds) | mJ/cm² | (minutes) | (psi) |
| I | steel | 0.3 | 22.5 | | * |
| J | steel | 0.3 | 22.5 | | 1880 |
| J | steel | 0.7 | 52.5 | | 2600 |
| J | steel | 0.7 | 52.5 | 10 | 1600 |
| I | steel | n/a | | | 240 |
| J | steel | n/a | | | 800 |
| I | glass | n/a | | | 0 |
| J | glass | n/a | | | 0 |

* assembly broke, no reading

### EXAMPLE 53

Formulation I was used in an additional set of experiments on glass slides to assess the impact of open time. The glass slides were prepared consistent with those mentioned above and exposed to the above-mentioned fiber optic UV source with an intensity of 2.5 W/cm² at the source, 1.5 inches from the sample, for either 0.3 of 0.5 seconds. The UV irradiated glass slides were then allowed to stand for varying open times before a second glass slide was applied over the exposed adhesive. These assemblies were then evaluated for their cure characteristics at various intervals. The details of each experiment and the results attained thereby are set forth in Table 9.

TABLE 9

| | Open | | | | | | | | |
|---|---|---|---|---|---|---|---|---|---|
| Exposure | Time | | | | | | | | |
| Time | (min- | Cure Time (Minutes) | | | | | | | |
| (seconds) | utes) | 3 | 5 | 8 | 10 | 20 | 30 | 50 | Overnight |
| 0.3 | 0 | | 7 | | 7.5 | >9.5 | >9.5 | >9.5 | >9.5 |
| 0.3 | 10 | | | 3 | 5 | 7 | 8 | | 9.9 |
| 0.3 | 20 | | | | 5 | 7 | 7 | 8 | 99 |
| 0.3 | 60 | | | | 6 | | | | |
| 0.5 | 0 | 5 | 8 | | | | | | |

The results shown in Table 9 suggest that the duration of open time has little effect upon cure characteristic; however, it seems most beneficial to have no open time.

### EXAMPLE 54

A series of adhesive formulations were prepared for purposes of demonstrating the impact of the omission of one or more of the non-acrylate ester components. The makeup of each of these formulations was as set forth in Table 10. These samples were tested on glass slides exposed to the fiber optic UV source, 2.54 W/cm², at a distance of 1.5 inches.

TABLE 10

| | Formulation | | | | |
|---|---|---|---|---|---|
| Component | K | L | M | N | O |
| Ebecryl 1290^{a} | 8.25 | 8.25 | 8.25 | 8.25 | 8.25 |
| SR 454^{b} | 15.2 | 15.0 | 15.0 | 15.0 | 15.0 |
| Ferrocene | 0.18 | 0.18 | 0.18 | 0.18 | |
| Cumene | 0.62 | | 0.62 | | 0.62 |
| hydroperoxide | | | | | |
| UVI 6992^{c} | 0.75 | | | 0.75 | 0.75 |

^{a}aliphatic urethane hexaacrylate (Cytec Industries Inc.)
^{b}ethoxylated trimethylolpropane triacrylate (Sartomer Company, Inc.)
^{c}mixed triarylsulfonium hexafluorophosphate salts (The Dow Chemical Company)

The cure characteristics of these examples were as presented in Table 11. These examples show the importance of all three elements (Formulation K) of the cure system, i.e., the peroxide, ferrocene and, most importantly, the strong acid, in order to attain good cure with short exposure times employed by applicants.

TABLE 11

| Exposure | Estimated | Cure | Formulation | | | | | | |
|---|---|---|---|---|---|---|---|---|---|
| Time | Accumulated | Time | K | L | M | N | | O | |
| (seconds) | Energy mJ/cm² | (hours) | 1 | 24 | 24 | 4 | 24 | 4 | 24 |
| 0.3 | 22.5 | | >9.5 | 0 | 0 | 0 | 0 | 0 | 0 |
| 0.5 | 37.5 | | | 0 | 0 | 0 | 0 | 0 | 0 |
| 1.0 | 75.0 | | | 0 | 0 | 0 | 0 | 0 | 0 |
| 5.0 | 375 | | | 0 | 0 | 0 | 0 | 0 | 0 |
| 10.0 | 750 | | | 0 | 0 | 0 | 9.5 | 0 | >6 |
| 20.0 | 1500 | | | 0 | 0 | 0 | 9.5 | 0 | >6 |

### EXAMPLE 55

A series of formulations were prepared to demonstrate further embodiments of the present invention as welt as the impact of the presence of certain traditional additives for anaerobic adhesives. The specific formulations are set forth in Table 12.

TABLE 12

| | Formulation | | | | | |
|---|---|---|---|---|---|---|
| Component | P | Q | R | S | T | U |
| Ebecryl 1290^{a} | 8.25 | 8.25 | 8.25 | | | |
| SR 454^{b} | 15.0 | 15.0 | 14.25 | | 8.8 | 8.0 |
| CN991^{c} | | | | 25.0 | | |
| CN961E75^{d} | | | | | 20.0 | |
| CN963E75^{e} | | | | | | 20.0 |
| Hydroxy propyl methacrylate | | | | 5.0 | | |
| Acrylic acid | | | 0.75 | | | |
| ferrocene | | 0.38 | | 0.38 | 0.38 | 0.38 |
| n-butyl ferrocene | 0.38 | | 0.38 | | | |
| Cumene hydroperoxide | 0.62 | 0.62 | 0.62 | 0.62 | 0.62 | 0.62 |
| UVI 6992^{f} | 0.75 | 0.75 | 0.75 | 0.75 | 0.75 | 0.75 |

^{a}aliphatic urethane hexaacrylate (Cytec Industries Inc.)
^{b}ethoxylated trimethylolpropane triacrylate (Sartomer Company, Inc.)
^{c}urethane acrylate (Sartomer Company, Inc.)
^{d}urethane acrylate/ethoxylated trimethylolpropane triacrylate mix (Sartomer Company, Inc.)
^{e}urethane acrylate/ethoxylated trimethylolpropane triacrylate mix (Sartomer Company, Inc.)
^{f}mixed triarylsulfonium hexafluorophosphate salts (The Dow Chemical Company)

These formulations were applied to glass slides and exposed to UV light from the above-mentioned fiber optic UV source, consistent with the foregoing examples. Three UV intensities were evaluated, 1.1 W/cm², 2.5 W/cm² and 4.5 W/cm², at two different distances of the slide to the light source, 1.5 inches, 2.5 inches, and 3.75 inches. The exposure times varied, 0.1, 0.2, 0.3, 0.5, 0.7, 1.0, 2.0, 3.0 and 4.0 seconds, and an open time of 5 minutes was employed occasionally. Because of the complexity and number of examples and variables, general observations will be made relative to the performance of the compositions prepared and tested rather than presenting the conditions and results for each sample tested.

Generally speaking, with the exception of Formulation R, all formulations and samples performed well. Formulation R cured prematurely due, it is believed to the presence of the acrylic acid. Thus, acidic constituents are to be avoided unless they are of sufficiently low acidity. Preferably it is desired to prepare formulations that are acid-free so as to avoid any potential concerns with their use.

The selection of the acrylic ester component had some impact on cure speed, especially at the higher intensities. In particular, those formulations having the urethane acrylate component tended to cure more quickly with the higher intensity light, i.e., 4.5 W/cm² at 3.75 inches. At the lower intensities and shorter distances, fast cure was noted for exposures of 0.3 seconds and higher. With the shorter exposures cure was generally attained overnight. On the other hand, the higher intensity exposures tended to increase cure speed, and thus cure, even in the shorter exposure times of 0.1 and 0.2 seconds. Allowing the sample to remain open for a period 5 following UV exposure before mating the substrates seemed to slow down the cure speed; though again, good overnight cure was achieved. Finally, some amount of precure was often seen in samples exposed for 1.0 second or greater, though these samples still provided good overall cure. It is believed that proper addition of stabilizers will reduce the occurrence of such precure.

### EXAMPLES 56-65

In an effort to demonstrate the versatility of the present invention to binary adhesive systems, a UV activatable anaerobic adhesive formulation, formulation “AN-V”, having the general composition set forth in Table 13 was combined with various caprolactone based hot melt adhesives sold under the CAPA trademark from Solvay Chemicals, LaPorte, Tex., and the mixture evaluated for cure speed and performance: the latter measured by a change in the effective melting point of the hot melt adhesive. The various formulations evaluated were as presented in Table 14. To aid in the mixing of the adhesive formulations, the caprolactone hot melts were first diluted with about 50% by weight of MEK before mixing in the anaerobic adhesive composition.

TABLE 13

| Component | Wt % |
|---|---|
| Ebecryl 1290^{a} | 34 |
| SR 454^{b} | 60 |
| Ferrocene | 0.72 |
| Cumene hydroperoxide | 2.5 |
| DER 736^{c} | |
| UVI 6992^{d} | 0.75 |

^{a}aliphatic urethane hexaacrylate (Cytec Industries Inc.)
^{b}ethoxylated trimethylolpropane triacrylate (Sartomer Company, Inc.)
^{c}diglycidal ether of propylene glycol (The Dow Chemical Company)
^{d}mixed triarylsulfonium hexafluorophosphate salts (The Dow Chemical Company)

Two sets of test specimens were prepared. In one set, identified as “Closed” in Table 14, several drops of the adhesive formulation was placed on a glass slide and allowed to coat the surface. The slide was left open until the MEK had evaporated after which the glass slide was then mated to a like glass slide before being exposed to UV light for the designated time. In the second set of examples, identified as “Closed” in Table 14, the same steps were followed except that the “dried” adhesive was exposed to UV light before mating the glass slides. In all instances, the glass slides were exposed to UV light of 2.5 W/cm² at a distance of 1.5 inches for the time indicated. The mated slides were allowed to stand overnight before being tested for cure or fixture. Compositions that cured were also evaluated for any change in melting point. The results of these evaluations are also presented in Table 14. As noted, the addition of the second adhesive material caused the anaerobic systems to be slightly less active, necessitating some what longer exposure times. In this regard when a second adhesive system is employed, exposure times of up to one minute, preferably no more than about 30 seconds may be used. Although not intending to be bound by theory, it is believed that the secondary adhesive may be absorbing some of the UV energy and/or the dilution of the cure system of the anaerobic formulation. Alternatively, and preferably, one may also increase the amounts of the components of the cure system in order to account for the dilutive effect of the secondary adhesive composition. Simple adjustments

TABLE 14

| Comonent | 56 | | 57 | | 58 | | 59 | | 60 | | 61 | | 62 | | 63 | | 64 | | 65 | |
|---|---|---|---|---|---|---|---|---|---|---|---|---|---|---|---|---|---|---|---|---|
| AN-V | 9 | | 17 | | 9 | | 17 | | 35 | | 9 | | 17 | | 35 | | 9 | | 17 | |
| CAPA 2100 | 91 | | 83 | | | | | | | | | | | | | | | | | |
| CAPA 3050 | | | | | 91 | | 83 | | 65 | | | | | | | | | | | |
| CAPA 4101 | | | | | | | | | | | 91 | | 83 | | 65 | | | | | |
| CAPA 6250 | | | | | | | | | | | | | | | | | 91 | | 83 | |
| MP (° C.) | | 30 | | 30 | | 0 | | 0 | | 0 | | 10 | | 10 | | 10 | | 55 | | 55 |
| UV Exposure | | | | | | | | | | | | | | | | | | | | |
| (sec) | | | | | | | | | | | | | | | | | | | | |
| Closed | | | | | | | | | | | | | | | | | | | | |
| 5 | | | Y | >110 | N | | Y | >110 | | | | | | >110 | | | | | Y | >170 |
| 10 | N | | Y | >110 | Y | >110 | | | | | N | | | >110 | | | Y | >110 | Y | >170 |
| 20 | Y | >110 | | | | | | | | | Y | >110 | | | | | Y | >110 | | |
| Open | | | | | | | | | | | | | | | | | | | | |
| 0.5 | | | | | | | | | N | | | | | | N | | | | | |
| 1 | | | | | | | N | | N | | | | N | | N | | | | | |
| 2 | | | | | | | N | | Y* | >110 | | | N | | Y* | 90 | | | | |
| 5 | | | | | | | N | | Y* | >110 | | | N | | Y* | >110 | | | | |
| 10 | | | | | | | N | | | | | | N | | | | | | | |

Y* - these systems cured in less than 2 hours following exposure.

in the formulations may be made by those skilled in the art to overcome any such dilution effect: the latter also including the possibility that certain components of the anaerobic cure system may be involved in or scavenged by the secondary adhesive system and/or its cure mechanism. This will also hold true for other binary systems in which the presence of the secondary adhesive system adversely affects the cure and cure speed of the neat anaerobic composition.

Perhaps most significant and surprising from the results presented in Table 14 is the marked increase in the melting points of the various polycaprolactones resulting from the incorporation and subsequent cure therein of the anaerobic curable composition. Such a significant increase in melt temperature markedly increases the number and types of applications into which these materials may now be used: both with respect to the end-use applications and heat resistance of the hot melt adhesive as well as the heat resistance or sensitivity of the underlying substrate to which it is applied. In the alternative, such modification of melting temperatures allows one to use hot melts of lower melting points than would have been attainable without the presence of the anaerobic composition to achieve the same heat resistance in the finished product. This, then facilitates the use of less energy overall and lower operating temperatures: saving on energy costs as well as lessening problems with injury and other consequences of higher temperature operating conditions and equipment.

Another attribute of these anaerobic adhesive/hot melt binary systems is the fact that one may attain many benefits of a traditionally reactive hot melt, most notably cross-linking and the attendant benefits thereof, without concern as to the adequacy of the conditions for effecting the cross-linking of the reactive hot melt itself. For example, certain reactive hot melts cross-link by a moisture cure involving urethanes. However, since ambient moisture varies from region to region as well as from day-to-day, variability is oftentimes found with the performance of such reactive hot melts. Since moisture is not relevant to the inventive system of the present invention, these systems are less environmentally sensitive.

### EXAMPLES 66-71

A second series of binary adhesive compositions was prepared: this time using two conventional acrylic based pressure sensitive adhesive emulsions. The first was an acid free acrylic composition from Avery Dennison of Pasadena, Calif. and the second a weak acid containing composition from National Starch of Bridgewater, N.J. Both polymers were supplied as solutions of the polymer in a solvent, the acid free composition containing 40 wt percent polymer and the weak acid composition containing 50 wt percent polymer. These materials were combined with the anaerobic composition employed in the previous set of examples, AN-V. As in the preceding examples, the formulations were applied to glass slides and the solvent allowed to evaporate before the glass slides were assembled and exposed to UV light for a period of 0.3 seconds. The specific binary adhesive formulations prepared and their performance characteristics were as set forth in Table 15. Except where indicated, the amounts are presented in parts by weight. Solubility was evaluated using a 50:50 mixture of acetone and toluene.

The results shown in Table 15 indicate that the inventive anaerobic compositions may be incorporated into a pressure sensitive adhesive without adversely affecting the tackiness of the pressure sensitive adhesive before anaerobic cure while providing marked improved properties to the same composition following anaerobic cure. For example, the presence of the cured acrylic network will reduce, if not eliminate creep in the pressure sensitive adhesive: what creep may exist will tend to be that occurring prior to anaerobic polymerization.

Perhaps of more importance is that fact that one may now use pressure sensitive adhesives of lower molecular weight or whose solid content is of lower molecular weight: the latter enabling higher solids content with minimal, if any, impact on viscosity of the binary blend of the anaerobic and pressure sensitive adhesive prior to UV exposure. In essence one may markedly increase the solids content of the pressure sensitive adhesive and still have a workable composition. By adjusting the amount of anaerobic curable composition employed, one may eliminate or reduce creep while also increasing the thermal resistance of the pressure sensitive adhesive without necessarily attaining a fully cross-linked system. Thus, enhancing productivity, especially of the coating equipment, and reducing the amount of solvents used. Furthermore, the decreased solubility of the cured binary pressure sensitive/anaerobic adhesive indicates that these materials may now be employed in applications heretofore unsuitable for the such pressure sensitive adhesives.

TABLE 15

| | 66 | 67 | 68 | 69 | 70 | 71 |
|---|---|---|---|---|---|---|
| Component | | | | | | |
| AV-N | 17.1 | 10.0 | 4.4 | 21.4 | 12.5 | 5.6 |
| Acid Free | 100 | 100 | 100 | | | |
| Weak Acid | | | | 100 | 100 | 100 |
| % AN-V* | 30 | 20 | 10 | 30 | 20 | 10 |
| Tackiness | | | | | | |
| Pre-cure | Yes | Yes | Yes | Yes | Yes | Yes |
| Post cure | No | Slight | Yes | No | Slight | Yes |
| Solubility | | | | | | |
| Cured PSA^{a} | Yes | Yes | Yes | Yes | Yes | Yes |
| Pre-cure | Yes | Yes | Yes | Yes | Yes | Yes |
| Post cure | No | Minor | Partial | No | Minor | Partial |

*wt percent anaerobic adhesive based on the solids (polymer) content of the pressure sensitive adhesive composition
^{a}solubility of the pure, “set” PSA: free of anaerobic adhesive

### EXAMPLE 72

To further show the applicability of other peroxy free radical initiators to the compositions and methods of the present invention, two alternative peroxy free radical initiators were evaluated; t-amyl hydroperoxide and t-butyl hydroperoxide. These peroxy initiators were substituted on a weight for weight basis for the cumene hydroperoxide in anaerobic formulation K of Example 54 above. The formulations were applied to glass slides which were then mated with another glass slide and exposed to UV light for 0.3 seconds. Following UV exposure, both formulations cured within 1 hour and achieved a Cure Characteristic rating of 9.5.

While the present invention has been described with respect to aforementioned specific embodiments and examples, it should be appreciated that other embodiments utilizing the concept of the present invention are possible without departing from the scope of the invention. The present invention is defined by the claimed elements and any and all modifications, variations, or equivalents that fall within the spirit and scope of the underlying principles embraced or embodied thereby.

We claim:

1. An activated, anaerobically curable adhesive composition comprising
a. one or more free radical polymerizable monomers, oligomers, prepolymers or a combination of any two or more of the foregoing,
b. a peroxy free radical initiator,
c. a strong acid, and
d. optionally, except where the adhesive is to be employed on an inactive surface in which case it is not optional, a transition metal ion source;
wherein the strong acid has been generated in-situ from a UV activated strong acid precursor as a result of exposing the anaerobic adhesive composition containing the strong acid precursor to a UV light source for from about 0.01 up to 20 seconds: said strong acid being capable of interacting with the peroxy free radical initiator in the presence of a transition metal ion to generate free radicals in a sufficient amount to enable the composition to “fully cure” under anaerobic conditions in less than 24 hours.

2. The adhesive composition of claim 1 wherein the strong acid has been generated by exposing the adhesive composition to UV light for from 0.05 to 5 seconds.

3. The adhesive composition of claim 1 wherein the strong acid has been generated by exposing the adhesive composition to UV light for from 0.1 to 1.0 second.

4. The adhesive composition of claim 1 wherein the intensity of the UV light at the surface of the adhesive composition is from about 25 to about 500 milliwatts/cm2.

5. The adhesive composition of claim 1 wherein the intensity of the UV tight at the surface of the adhesive composition is from about 70 to about 300 milliwatts/cm².

6. The adhesive composition of claim 1 wherein the amount of accumulated energy in the adhesive composition during the UV activation of the acid precursor is no more than about 1000 millijoules/cm².

7. The adhesive composition of claim 1 wherein the amount of accumulated energy in the adhesive composition during the UV activation of the acid precursor is no more than about 250 millijoules/cm².

8. The adhesive composition of claim 1 wherein the amount of accumulated energy in the adhesive composition during the UV activation of the acid precursor is no more than about 100 millijoules/cm².

9. The adhesive composition of claim 1 wherein the acid precursor is sulfonium UV photoinitiator.

10. The adhesive composition of claim 1 wherein the acid precursor is a triarylsulfonium salt.

11. The adhesive composition of claim 1 wherein the transition metal ion source is present.

12. The adhesive composition of claim 11 wherein the transition metal ion source is a metallocene.

13. The adhesive composition of claim 11 wherein the metallocene is selected from the group consisting of i) the dicyclopentadienyl-metals with the general formula (C₅H₅)₂M, ii) the dicyclopentadienyl metal halides of the formula (C₅H₅)₂MXₛ, where X is a halide, and s is 1, 2 or 3; iii) monocyclopentadienyl-metal compounds with the general formula C₅H₅MR⁷ₛ where s is as defined above and R⁷ is CO, NO, a halide group, or an alkyl group and iv) polymers having a metallocene moiety.

14. The adhesive composition of claim 13 wherein the transition metal is copper or iron.

15. The adhesive composition of claim 1 wherein the transition metal source is present and is selected from the group consisting of ferrocene and substituted ferrocene compounds.

16. The adhesive composition of claim 1 wherein the peroxy initiator is selected from the group consisting of peroxides, peresters and hydroperoxides.

17. The adhesive composition of claim 16 wherein the peroxy initiator is a hydrogen peroxide.

18. The adhesive composition of claim 1 comprising:
a. from about 50 to about 99.9 wt % of the free radical polymerizable material;
b. from about 0.05 to about 10 wt % of a peroxy free radical initiator;
c. from about 0.05 to about 10 wt. % of a transition metal source; and
d. the strong acid wherein the composition, prior to exposure to the UV source contained from about 0.1 to about 15 wt % of the strong acid precursor.

19. The adhesive composition of claim 11 wherein the strong acid precursor was present in an amount of from about 0.4 to about 10 wt %.

20. The adhesive composition of claim 1 wherein the composition was acid free prior to UV exposure activation.

21. The adhesive composition of claim 1 wherein cure is effected within 4 hours.

22. The adhesive composition of claim 1 wherein a fixture cure is effected within 2 hours.

23. The adhesive composition of claim 1 wherein cure is effected within 4 hours and fixture cure within 1 hour.

24. The adhesive composition of claim 1 further comprising a second adhesive system and wherein the cure is effected within 24 hours following exposure to UV light for a period of up to about 1 minute.

25. The adhesive composition of claim 24 wherein the second adhesive system is selected from a pressure sensitive adhesive and a hot melt adhesive.

26. The adhesive composition of claim 24 wherein the anaerobic composition set forth in claim 1 is preset at a level of at least 2 weight percent.

27. A method of bonding surfaces with an anaerobic adhesive composition, said method comprising:
(i) coating a first surface with an anaerobic adhesive composition;
(ii) exposing the anaerobic adhesive composition to UV light for from 0.01 to 20 seconds;
(iii) mating the coated first surface with a second surface so as to substantially exclude air from interacting with the anaerobic adhesive composition; and
(iv) allowing the anaerobic adhesive formulation to cure,
said method steps (i) and (ii) occurring sequentially, concurrently or in reverse order; wherein the anaerobic adhesive composition, prior to exposure to the UV light, comprises (a) one or more free radical polymerizable monomers, oligomers, prepolymers or a combination of any two or more of the foregoing, (b) a peroxy free radical initiator, c) a UV activated strong acid precursor, and (d) optionally, except where the adhesive is to be employed on an inactive surface in which case it is not optional, a transition metal ion source compound; and
wherein the exposure of the anaerobic adhesive composition to UV light generates a strong acid, said strong acid being capable of interacting with the peroxy free radical initiator in the presence of a transition metal ion to generate free radicals in a sufficient amount to enable the composition to cure under anaerobic conditions in less than 24 hours.

28. The method of claim 27 wherein the anaerobic adhesive composition is exposed to the UV light following application to the first surface.

29. The method of claim 27 wherein the anaerobic adhesive composition is exposed to the UV light prior to or during application to the first surface.

30. The method of claim 27 wherein the anaerobic adhesive composition is exposed to the UV light for between 0.05 and 5 seconds.

31. The method of claim 27 wherein the intensity of the UV light at the surface of the adhesive composition is from about 25 to about 500 milliwatts/cm².

32. The method of claim 27 wherein the intensity of the UV light at the surface of the adhesive composition is from about 70 to about 300 milliwatts/cm².

33. The method of claim 27 wherein the amount of accumulated energy in the adhesive composition during the UV activation of the acid precursor is no more than about 1000 millijoules/cm².

34. The method of claim 27 wherein the amount of accumulated energy in the adhesive composition during the UV activation of the acid precursor is no more than about 250 millijoules/cm².

35. The method of claim 27 wherein the amount of accumulated energy in the adhesive composition during the UV activation of the acid precursor is no more than about 200 millijoules/cm².

36. The method of claim 27 wherein the UV activated acid precursor is an iodonium or sulfonium UV photoinitiator.

37. The method of claim 27 wherein the acid precursor is a sulfonium compound.

38. The method of claim 27 wherein the transition metal ion source is present.

39. The method of claim 38 wherein the transition metal ion source is a metallocene.

40. The method of claim 38 wherein the metallocene is selected from the group consisting of i) the dicyclopentadienyl-metals with the general formula (C₅H₅)₂M, ii) the dicyclopentadienyl metal halides of the formula (C₅H₅)₂MXₛ, where X is a halide, and s is 1, 2 or 3; iii) monocyclopentadienyl-metal compounds with the general formula C₅H₅MR⁷ₛ where s is as defined above and R⁷ is CO, NO, a halide group, or an alkyl group and iv) polymers having a metallocene moiety.

41. The method of claim 40 wherein the transition metal is copper or iron.

42. The method of claim 27 wherein the transition metal source is present and is selected from the group consisting of ferrocene and substituted ferrocene compounds.

43. The method of claim 27 wherein the peroxy initiator is selected from the group consisting of peroxides, peresters and hydroperoxides.

44. The method of claim 27 wherein the peroxy initiator is a hydrogen peroxide.

45. The method of claim 27 comprising:
a. from about 50 to about 99.9 wt % of the free radical polymerizable material;
b. from about 0.05 to about 10 wt % of a peroxy free radical initiator;
c. from about 0.05 to about 10 wt. % of a transition metal source; and
d. the strong acid wherein the composition, prior to exposure to the UV source contained from about 0.1 to about 15 wt % of the strong acid precursor.

46. The method of claim 27 wherein the adhesive composition further comprises a second adhesive system and the adhesive is subjected to UV light for a period of up to 1 minute.

47. The method of claim 46 wherein the anaerobic curable composition is present in an amount of at least 2 weight percent.

48. The method of claim 46 wherein the second adhesive system is selected from pressure sensitive adhesives and hot melt adhesives.

49. The method of claim 27 wherein one of the substrates to be bonded is transparent to UV light and the adhesive formulation is exposed to the UV source following the mating of the substrates by irradiation through the UV transparent substrate.

50. The method of claim 27 wherein the method is practiced on an automated, high speed assembly line.

51. A curable adhesive composition comprising a first component curable under anaerobic conditions by free radical polymerization following exposure to UV and a second component curable or settable by a condition other than anaerobic conditions.

52. The curable composition of claim 51 wherein the second component comprises:
a. one or more free radical polymerizable monomers, oligomers, prepolymers or a combination of any two or more of the foregoing,
b. a peroxy free radical initiator,
c. a strong acid precursor capable of releasing or generating a strong acid upon exposure to UV light, and
d. optionally, except where the adhesive is to be employed on an inactive surface in which case it is not optional, a transition metal ion source.

53. The curable composition of claim 52 wherein strong acid precursor is of such type and present at such level that exposure to UV light for up to about one minute is sufficient to generate sufficient strong acid such that the strong acid, in the presence of a transition metal ion, will react with the free radical initiator to generate free radicals in a sufficient amount to enable the first component of the composition to “fully cure” under anaerobic conditions in less than 24 hours.

54. The curable composition of claim 52 wherein the first component comprises:
a. from about 50 to about 99.9 wt % of the free radical polymerizable material;
b. from about 0.05 to about 10 wt % of a peroxy free radical initiator;
c. from about 0.1 to about 15 wt % of the strong acid precursor, and
d. if present, from about 0.05 to about 10 wt. % of a transition metal source, all weight percents being based on the total weight of the first component.

55. The curable composition of claim 52 wherein the second component is a hot melt adhesive or a pressure sensitive adhesive.

56. The curable composition claim 52 wherein the first component is present in an amount of at least 2 wt percent of the overall composition.

57. The curable composition of claim 52 wherein the first component in its neat form is capable of full cure within 24 hours under anaerobic conditions following exposure to UV light for up to 20 seconds.

58. An assembly comprising two substrates, at least one of which is transparent to UV light, and an anaerobic free radical polymerizable adhesive composition at the interface between the two substrates, wherein the anaerobic free radical polymerizable adhesive composition comprises:
a. one or more free radical polymerizable monomers, oligomers, prepolymers or a combination of any two or more of the foregoing,
b. a peroxy free radical initiator,
c. a strong acid precursor capable of releasing or generating a strong acid upon exposure to UV light, and
d. optionally, except where the adhesive is to be employed on an inactive surface in which case it is not optional, a transition metal ion source.

59. The assembly of claim 58 wherein the adhesive composition comprises a binary adhesive having as a first component thereof the anaerobic free radical polymerizable adhesive and as a second component thereof another adhesive that is not UV activated.

60. The assembly of claim 59 wherein the second component is a hot melt adhesive or a pressure sensitive adhesive and the first component is present in an amount of at least 2 weight percent of the overall composition.
